(19) United States
(12) Patent Application Publication
(10) Pub. No.: US 2023/0322981 A1
(43) Pub. Date: Oct. 12, 2023

(54) CURABLE RESIN COMPOSITION, CURED PRODUCT, DIFFRACTIVE OPTICAL ELEMENT, MULTILAYER DIFFRACTIVE OPTICAL ELEMENT, AND OXIDE NANOPARTICLES

(71) Applicant: FUJIFILM Corporation, Tokyo (JP)

(72) Inventors: Masahiro TAKATA, Ashigarakami-gun, Kanagawa (JP); Masashi ONO, Ashigarakami-gun, Kanagawa (JP); Naozumi SHIRAIWA, Ashigarakami-gun, Kanagawa (JP)

(73) Assignee: FUJIFILM Corporation, Tokyo (JP)

(21) Appl. No.: 18/148,031

(22) Filed: Dec. 29, 2022

(30) Foreign Application Priority Data
Jan. 31, 2022 (JP) 2022-012740

(51) Int. Cl. C08F 120/12; C08K 3/22

(52) U.S. Cl. CPC C08F 120/12; C08K 3/22; C08K 2003/2213; C08K 2003/2231

(57) ABSTRACT

An object of the present invention is to provide a cured product which is suitable as a material for a layer of low refractive index in a multilayer diffractive optical element, can exhibit a desired chromatic aberration reducing effect over a near-infrared wavelength region to a shortwave infrared wavelength region in a case of being used in the multilayer diffractive optical element, and can exhibit high transmittance in this wavelength range; a curable resin composition suitable for obtaining this cured product; and a diffractive optical element and a multilayer diffractive optical element including this cured product. Provided are a curable resin composition which includes oxide nanoparticles including indium and cerium, a monofunctional or higher functional (meth)acrylate compound, and a dispersant; a cured product formed of the curable resin composition; a diffractive optical element and a multilayer diffractive optical element; and oxide nanoparticles used in this composition.

### CROSS-REFERENCE TO RELATED APPLICATIONS

This application claims priorities under 35 U.S.C. § 119 (a) to Japanese Patent Application No. 2022-012740 filed in Japan on Jan. 31, 2022. The above application is hereby expressly incorporated by reference, in its entirety, into the present application.

### BACKGROUND OF THE INVENTION

### 1. Field of the Invention

The present invention relates to a curable resin composition.

The present invention also relates to a cured product obtained using the curable resin composition, a diffractive optical element, and a multilayer diffractive optical element.

The present invention also relates to oxide nanoparticles used in the curable resin composition.

### 2. Description of the Related Art

By using a diffractive optical element, it is possible to obtain a lens which has a shorter focal length as the wavelength is longer, and exhibits chromatic aberration opposite to that of a refractive lens in the related art. Unlike the refractive lens requiring a plurality of lenses for correcting chromatic aberration, chromatic aberration can be corrected by changing the period of a diffraction structure of a lens, therefore a more compact and high-performance lens unit can be designed by using the diffractive optical element.

In a multilayer diffractive optical element having a configuration in which diffractive optical elements formed of two different materials are in contact with each other on lattice planes thereof, by forming one diffractive optical element with a material having a relatively high refractive index and high Abbe number, and forming the other diffractive optical element with a material having a relatively low refractive index and low Abbe number, it is possible to suppress the occurrence of flare in the lens, and the like, and sufficiently utilize a chromatic aberration reducing effect. In this case, in a case where the two diffractive optical elements have optical characteristics in which the difference in refractive index between the two diffractive optical elements is larger at a longer wavelength, the chromatic aberration reducing effect can be obtained in a wide wavelength range.

In recent years, in order to obtain, as described above, the chromatic aberration reducing effect in a wide wavelength range, it has been proposed to add indium tin oxide (ITO) particles to a low Abbe number diffractive optical element in the multilayer diffractive optical element. For example, JP2006-220689A discloses, as a curable resin composition for producing a diffractive optical element, a curable resin composition in which ITO particles are dispersed in a resin containing a photopolymerization initiator, a dispersant, and a mixture of two or more acryloyl groups, methacryloyl groups, or vinyl groups, or unsaturated ethylene groups thereof.

In addition, WO2020/171197A discloses a resin composition including ITO particles and a near-ultraviolet light-absorbing organic compound. According to WO2020/171191A, it is disclosed that, by curing this resin composition, a refractive index of the obtained cured product in the near-infrared wavelength region can be lowered, and wavelength dependence of the refractive index of the cured product can be adjusted by increasing the refractive index in the near-ultraviolet wavelength region, so that desired wavelength dependence of the refractive index can be achieved by suppressing a blending amount of ITO particles, thereby achieving the desired low refractive index and low Abbe number even in a case where a transmittance of the cured product in the near-infrared wavelength region is increased.

### SUMMARY OF THE INVENTION

In the related art, a general camera has been assumed as an application target of a lens using a diffractive optical element. Therefore, as disclosed in JP2006-220689A or WO2020/171197A, in the visible light wavelength region visible to human or in the near-infrared wavelength region from visible light to approximately 1.0 μm, in a case of using the multilayer diffractive optical element (also referred to as a laminated diffractive optical element), development has been conducted to obtain a diffractive optical element which has a chromatic aberration reducing effect and exhibit a low Abbe number showing high transmittance (large wavelength dependence of the refractive index) in this wavelength range.

On the other hand, in various inspections such as an electronic substrate inspection and a solar cell inspection, a shortwave infrared imaging technique using light in a shortwave infrared wavelength region of approximately 1.0 to 1.7 μm is used. Therefore, in a case of being used in a multilayer diffractive optical element, the lens to be applied can also obtain a chromatic aberration reducing effect in a wide wavelength range from the near-infrared wavelength region to the shortwave infrared wavelength region, and there is a demand for a diffractive optical element which has the desired wavelength dependence of the refractive index as a diffractive optical element used in a near-refractive index layer and exhibits high transmittance in this wide wavelength range.

The present inventors have studied on a technique to apply a diffractive optical element, in which the chromatic aberration reducing effect can be obtained in a case of being used as a layer of low refractive index in the multilayer diffractive optical element by adjusting the wavelength dependence of the refractive index by adding ITO particles, to an optical system which uses light in the above-described near-infrared wavelength region to the shortwave infrared wavelength region. As a result, it has been found that it is difficult for the ITO particles disclosed in JP2006-220689A or WO2020/171197A to achieve high transmittance over the entire wavelength range from the near-infrared wavelength region to the shortwave infrared wavelength region. Therefore, there is a demand for a new technique for achieving wavelength dependence of a desired refractive index and high transmittance in the near-infrared wavelength region to the shortwave infrared wavelength region.

An object of the present invention is to provide a cured product which is suitable as a material for a layer of low refractive index in a multilayer diffractive optical element, can exhibit a desired chromatic aberration reducing effect over a near-infrared wavelength region to a shortwave infrared wavelength region in a case of being used in the multilayer diffractive optical element, and can exhibit high transmittance in this wavelength range; and a curable resin composition suitable for obtaining this cured product. Another object of the present invention is to provide a diffractive optical element and a multilayer diffractive optical element including the cured product.

The above-described objects have been achieved by the following methods.

### [1]

A curable resin composition comprising:
oxide nanoparticles including indium and cerium;
a monofunctional or higher functional (meth)acrylate compound; and a dispersant.

### [2]

The curable resin composition according to [1],
in which the oxide nanoparticles include at least one element of zirconium, hafnium, or tin.

### [3]

The curable resin composition according to [2],
in which the oxide nanoparticles include tin.

### [4]

The curable resin composition according to any one of [1] to [3],
in which a cerium concentration of the oxide nanoparticles is 0.5 to 3.0 at %.

### [5]

The curable resin composition according to [2] or [3],
in which a total concentration of zirconium, hafnium, and tin in the oxide nanoparticles is 0.1 to 2.0 at %.

### [6]

The curable resin composition according to any one of [1] to [5],
in which a content of the oxide nanoparticles in the curable resin composition is 10% to 60% by mass.

### [7]

The curable resin composition according to any one of [1] to [6],
in which an average particle diameter of the oxide nanoparticles is 16 to 30 nm.

### [8]

The curable resin composition according to [7],
in which the average particle diameter of the oxide nanoparticles is 20 to 30 nm.

### [9]

The curable resin composition according to any one of [1] to [8], further comprising:
a photoradical polymerization initiator.

### [10]

A cured product obtained by curing the curable resin composition according to any one of [1] to [9].

### [11]

The cured product according to [10],
in which a refractive index at a wavelength of 852 nm is 1.500 to 1.650.

### [12]

The cured product according to [10] or [11],
in which a refractive index at a wavelength of 1530 nm is 1.300 to 1.550.

### [13]

A diffractive optical element including a surface which is formed of the cured product according to any one of [10] to [12] and has a diffraction grating shape.

### [14]

A multilayer diffractive optical element comprising:
a first diffractive optical element; and
a second diffractive optical element,
in which the first diffractive optical element is the diffractive optical element according to [13], and
a surface of the first diffractive optical element, which has a diffraction grating shape, and a surface of the second diffractive optical element, which has a diffraction grating shape, face each other.

### [15]

The multilayer diffractive optical element according to [14],
in which a refractive index of the second diffractive optical element at a wavelength of 852 nm is 1.550 to 1.700, and the refractive index is larger than a refractive index of the first diffractive optical element at the wavelength of 852 nm.

### [16]

The multilayer diffractive optical element according to [14] or [15],
in which the surface of the first diffractive optical element, which has a diffraction grating shape, and the surface of the second diffractive optical element, which has a diffraction grating shape, are in contact with each other.

### [17]

The multilayer diffractive optical element according to any one of [14] to [16], further comprising:
a transparent substrate,
in which the first diffractive optical element, the second diffractive optical element, and the transparent substrate are arranged in this order.

### [18]

Oxide nanoparticles comprising:
indium;
cerium; and
at least one element of tin, zirconium, or hafnium,
in which an average particle diameter is 16 to 30 nm.

### [19]

An additive for a lens which is used for adjusting a wavelength dependence of a refractive index, the additive comprising:
the oxide nanoparticles according to [18].

In the present invention, the expression of a compound and a substituent is used to include the compound itself and the substituent itself, a salt thereof, and an ion thereof. For example, a carboxy group or the like may have an ionic structure in which a hydrogen atom is dissociated, or may have a salt structure. That is, in the present invention, the “carboxy group” is used in the sense of including a carboxylic acid ion or a salt thereof. This also applies to other acidic groups. A monovalent or polyvalent cation in forming the above-described salt structure is not particularly limited, and examples thereof include inorganic cations and organic cations. In addition, specific examples thereof include alkali metal cations such as Na⁺, Li⁺, and K⁺, alkaline earth metal cations such as Mg²⁺, Ca²⁺, and Ba²⁺, and organic ammonium cations such as a trialkylammonium cation and a tetraalkylammonium cation.

In a case of the salt structure, the type of salt thereof may be one or a mixture of two or more thereof, salt-type and liberated acid-structured groups may be mixed in a compound, or a salt-structured compound and a liberated acid-structured compound may be mixed.

In the present invention, in a case of a plurality of substituents, linking groups, constitutional units, and the like (hereinafter, referred to as a substituent and the like) represented by a specific reference or formula, or in a case of simultaneously defining a plurality of the substituent and the like, unless otherwise specified, the substituent and the like may be the same or different from each other (regardless of the presence or absence of an expression “each independently”, the substituent and the like may be the same or different from each other). The same applies to the definition of the number of substituents and the like. In a case where a plurality of substituents and the like are near (particularly, adjacent to each other), unless otherwise specified, the substituents and the like may be linked to each other to form a ring. In addition, unless otherwise specified, a ring, for example, an alicyclic ring, an aromatic ring, or a heterocyclic ring may be further condensed to form a fused ring.

In the present invention, unless otherwise specified, with regard to a double bond, in a case where E-form and Z-form are present in the molecule, the double bond may be any one of these forms, or may be a mixture thereof.

In addition, in the present invention, unless otherwise specified, in a case where a compound has one or two or more asymmetric carbons, for such stereochemistry of asymmetric carbons, either an (R)-form or an (S)-form can be independently taken. As a result, the compound may be a mixture of optical isomers or stereoisomers such as diastereoisomers, or may be racemic.

In addition, in the present invention, the expression of the compound means that a compound having a partially changed structure is included within a range which does not impair the effects of the present invention. Further, a compound which is not specifically described as substituted or unsubstituted may have an optional substituent within a range which does not impair the effects of the present invention.

In the present invention, with regard to a substituent (the same applies to a linking group and a ring) in which whether it is substituted or unsubstituted is not specified, within a range not impairing the desired effect, it means that the group may have an optional substituent, and the number of substituents which may be included is not particularly limited. For example, “alkyl group” means to include both an unsubstituted alkyl group and a substituted alkyl group. Similarly, for example, “aryl group” means to include both an unsubstituted aryl group and a substituted aryl group.

In the present invention, in a case where the number of carbon atoms in a certain group is specified, the number of carbon atoms means the number of carbon atoms in the entire group, unless otherwise specified in the present invention or the present specification. That is, in a case of a form in which the group has a substituent, it means the total number of carbon atoms including the substituent.

In the present invention, a numerical range represented by using “to” means a range including numerical values described before and after “to” as a lower limit value and an upper limit value.

In the present invention, each component may be used alone or in combination of two or more thereof.

In a description of the content of each component in the curable resin composition according to the aspect of the present invention, in a case where the curable resin composition includes a solvent, the content of each component is based on the component composition obtained by removing the solvent from the curable resin composition. For example, in a case where a curable resin composition is composed of 20 parts by mass of a solvent, 40 parts by mass of a component A, and 40 parts by mass of a component B, for a total of 100 parts by mass, since the content of the component Ain the composition is based on 80 parts by mass excluding the solvent, the content thereof is 50% by mass.

In the present invention, “(meth)acrylate” represents either one or both of acrylate and methacrylate, and “(meth)acryloyl” represents either one or both of acryloyl and methacryloyl. The monomer in the present invention is distinguished from an oligomer and a polymer, and refers to a compound having a weight-average molecular weight of 1000 or less.

In the present invention, the term aliphatic hydrocarbon group means a group obtained by removing one optional hydrogen atom from a linear or branched alkane, a linear or branched alkene, or a linear or branched alkyne. In the present invention, the aliphatic hydrocarbon group is preferably an alkyl group obtained by removing one optional hydrogen atom from a linear or branched alkane.

Examples of the alkyl group include a methyl group, an ethyl group, a propyl group, an isopropyl group, a butyl group, an isobutyl group, a sec-butyl group, a tert-butyl group, a pentyl group, a 1-methylbutyl group, a 3-methylbutyl group, a hexyl group, a 1-methylpentyl group, a 4-methylpentyl group, a heptyl group, a 1-methylhexyl group, a 5-methylhexyl group, a 2-ethylhexyl group, an octyl group, a 1-methylheptyl group, a nonyl group, a 1-methyloctyl group, a decyl group, an undecyl group, a dodecyl group, a tridecyl group, a tetradecyl group, a pentadecyl group, a hexadecyl group, a heptadecyl group, an octadecyl group, a nonadecyl group, and an eicosyl group.

In addition, in the present invention, the aliphatic hydrocarbon group (unsubstituted) is preferably an alkyl group having 1 to 20 carbon atoms, and more preferably an alkyl group having 1 to 12 carbon atoms.

In the present invention, the term alkyl group means a linear or branched alkyl group. Examples of the alkyl group include the above-described examples. The same applies to an alkyl group in a group (an alkoxy group, an alkoxycarbonyl group, an acyl group, and the like) including the alkyl group.

In addition, in the present invention, examples of a linear alkylene group include a group obtained by removing one hydrogen atom bonded to a terminal carbon atom from a linear alkyl group among the above-described alkyl groups.

In the present invention, the term alicyclic hydrocarbon ring means a saturated hydrocarbon ring (cycloalkane). Examples of the alicyclic hydrocarbon ring include cyclopropane, cyclobutane, cyclopentane, cyclohexane, cycloheptane, cyclooctane, cyclononane, and cyclodecane.

In the present invention, the term unsaturated hydrocarbon ring means a hydrocarbon ring having a carbon-carbon unsaturated double bond, which is not an aromatic ring. Examples of the unsaturated hydrocarbon ring include indene, indane, and fluorene.

In the present invention, the term alicyclic hydrocarbon group means a cycloalkyl group obtained by removing one optional hydrogen atom from a cycloalkane. Examples of the alicyclic hydrocarbon group include a cyclopropyl group, a cyclobutyl group, a cyclopentyl group, a cyclohexyl group, a cycloheptyl group, a cyclooctyl group, a cyclononyl group, and a cyclodecyl group, and a cycloalkyl group having 3 to 12 carbon atoms is preferable.

In the present invention, a cycloalkylene group refers to a divalent group obtained by removing two optional hydrogen atoms from a cycloalkane. Examples of the cycloalkylene group include a cyclohexylene group.

In the present invention, the term aromatic ring means either one or both of an aromatic hydrocarbon ring and an aromatic heterocyclic ring.

In the present invention, the term aromatic hydrocarbon ring means an aromatic ring in which a ring is formed only by carbon atoms. The aromatic hydrocarbon ring may be a monocyclic ring or a fused ring. Examples of the aromatic hydrocarbon ring include benzene, biphenyl, biphenylene, naphthalene, anthracene, and phenanthrene. In the present invention, in a case where the aromatic hydrocarbon ring is bonded to another ring, it is sufficient that the aromatic hydrocarbon ring may be substituted on another ring as a monovalent or divalent aromatic hydrocarbon group.

In addition, in the present invention, the unsubstituted aromatic hydrocarbon ring is preferably an aromatic hydrocarbon ring having 6 to 14 carbon atoms.

In the present invention, the term monovalent aromatic hydrocarbon group (also referred to as an aryl group) means a monovalent group obtained by removing one optional hydrogen atom from the aromatic hydrocarbon ring. Examples of the monovalent aromatic hydrocarbon group include a phenyl group, a biphenyl group, a 1-naphthyl groups, a 2-naphthyl groups, a 1-anthracenyl group, a 2-anthracenyl group, a 3-anthracenyl group, a 4-anthracenyl group, a 9-anthracenyl group, a 1-phenanthryl group, a 2-phenanthryl group, a 3-phenanthryl group, a 4-phenanthryl group, and a 9-phenanthryl group. Among these, a phenyl group, a 1-naphthyl group, or a 2-naphthyl group is preferable.

In the present invention, the term divalent aromatic hydrocarbon group means a divalent group obtained by removing two optional hydrogen atoms from the aromatic hydrocarbon ring. Examples of the divalent aromatic hydrocarbon group include a divalent group obtained by removing one optional hydrogen atom from the above-described monovalent aromatic hydrocarbon group. Among these, a phenylene group is preferable, and a 1,4-phenylene group is more preferable.

In the present invention, an aromatic heterocyclic ring means an aromatic ring in which a ring is formed by at least one heteroatom and an atom selected from a carbon atom or a heteroatom. Examples of the heteroatom include an oxygen atom, a nitrogen atom, and a sulfur atom. The aromatic heterocyclic ring may be a monocyclic ring or a fused ring, and the number of atoms constituting the ring is preferably 5 to 20 and more preferably 5 to 14. The number of heteroatoms in the atoms constituting the ring is not particularly limited, but is preferably 1 to 3 and more preferably 1 or 2. Examples of the aromatic heterocyclic ring include a furan ring, a thiophene ring, a pyrrole ring, imidazole, isothiazole, isoxazole, pyridine, pyrazine, quinoline, benzofuran, benzothiazole, benzoxazole, and examples of nitrogen-containing fused aromatic ring described later. In the present invention, in a case where the aromatic heterocyclic ring is bonded to another ring, it is sufficient that the aromatic heterocyclic ring may be substituted on another ring as a monovalent or divalent aromatic heterocyclic group.

In the present invention, the term monovalent aromatic heterocyclic group (also referred to as a heteroaryl group) means a monovalent group obtained by removing one optional hydrogen atom from the aromatic heterocyclic ring. Examples of the monovalent aromatic heterocyclic group include a furyl group, a thienyl group (preferably, a 2-thienyl group), a pyrrolyl group, an imidazolyl group, an isothiazolyl group, an isooxazolyl group, a pyridyl group, a pyrazinyl group, a quinolyl group, a benzofuranyl group (preferably, a 2-benzofuranyl group), a benzothiazolyl group (preferably, a 2-benzothiazolyl group), and a benzoxazolyl group (preferably, a 2-benzoxazolyl group). Among these, a furyl group, a thienyl group, a benzofuranyl group, a benzothiazolyl group, or a benzoxazolyl group is preferable, and a 2-furyl group or a 2-thienyl group is more preferable.

In the present invention, the term divalent aromatic heterocyclic group means a divalent group obtained by removing two optional hydrogen atoms from the aromatic heterocyclic ring. Examples of the divalent aromatic heterocyclic group include a divalent group obtained by removing one optional hydrogen atom from the above-described monovalent aromatic heterocyclic group.

In the present invention, examples of a halogen atom include a fluorine atom, a chlorine atom, a bromine atom, and an iodine atom.

Since the curable resin composition according to the aspect of the present invention is a curable resin composition containing oxide nanoparticles including indium and cerium, by subjecting this composition to a curing reaction, in a case of being used in a multilayer diffractive optical element, it is possible to obtain a cured product which exhibits a desired wavelength dependence of a refractive index contributing to a reduction of chromatic aberration over a near-infrared wavelength region to a shortwave infrared wavelength region (hereinafter, also simply referred to as “wavelength dependence of refractive index”) while also exhibiting high transmittance over the entire wavelength range.

In addition, the cured product according to the aspect of the present invention can be suitably used as a material for a diffractive optical element and a multilayer diffractive optical element which exhibits a desired wavelength dependence of a refractive index contributing to a reduction of chromatic aberration over a near-infrared wavelength region to a shortwave infrared wavelength region while exhibiting high transmittance over the entire wavelength range.

### DESCRIPTION OF THE PREFERRED EMBODIMENTS

### Curable Resin Composition

A curable resin composition according to an embodiment of the present invention includes at least oxide nanoparticles including indium and cerium, a monofunctional or higher functional (meth)acrylate compound, and a dispersant.

The curable resin composition according to the embodiment of the present invention means a composition which has curing properties and with which a cured product (resin) can be obtained by a curing reaction.

The curable resin composition according to the embodiment of the present invention may include other components in addition to these components. Hereinafter, each component will be described.

### Oxide Nanoparticles Including Indium and Cerium

The curable resin composition according to the embodiment of the present invention contains oxide nanoparticles including indium and cerium (hereinafter, also referred to as “ICO particles (A)”).

In the present invention, the “oxide nanoparticles including indium and cerium” means nanoparticles composed of oxides of an element including indium and cerium.

By using the ICO particles (A) instead of the indium tin oxide particles (ITO particles) contained in the curable resin composition, as disclosed in JP2006-220689A, it is possible to obtain a cured product in which a decrease in transmittance in a shortwave infrared wavelength region (SWIR), which occurs in a case of adding the ITO particles, is suppressed. By using an oxide including indium and cerium as a compound which constitutes the nanoparticles, compared to a case of using the ITO particles, it is possible to adjust absorption to be sharper while maintaining a wavelength at which the maximal absorption is exhibited. Therefore, it is considered that the absorption of ICO particles (A) applied to SWIR in the base of absorption is reduced compared to the case of using the ITO particles and the transmittance in SWIR is improved.

The oxide of the element including indium and cerium, which constitutes the ICO particles (A), may be an oxide of an organic compound, an oxide of an inorganic compound, or a metal oxide as long as it includes indium and cerium.

In addition to the indium and cerium, from the viewpoint of sharpening the absorption of the ICO particles (A) and achieving better wavelength dependence of the refractive index, the ICO particles (A) preferably include at least one element of zirconium, hafnium, or tin, and more preferably include tin.

### Concentration of Constituent Elements

In the present invention, a concentration of an element a of the ICO particles (A) (the element a represents an arbitrary element α) means a proportion (at %) of the element α to metal elements constituting the ICO particles (A).

A cerium concentration of the ICO particles (A) can be, for example, 0.1 to 3.5 at %, and from the viewpoint of improving the wavelength dependence of the refractive index, the cerium concentration is preferably 0.5 to 3.0 at % and more preferably 0.5 to 2.0 at %.

In a case where the ICO particles (A) include zirconium, a zirconium concentration of the ICO particles (A) can be, for example, 3.0 at % or less, and is preferably 2.0 at % or less and more preferably 1.0 at % or less.

In a case where the ICO particles (A) include hafnium, a hafnium concentration of the ICO particles (A) can be, for example, 3.0 at % or less, and is preferably 2.0 at % or less and more preferably 1.0 at % or less.

In a case where the ICO particles (A) include tin, a tin concentration of the ICO particles (A) can be, for example, 3.0 at % or less, and is preferably 2.0 at % or less and more preferably 1.5 at % or less.

The total concentration of zirconium, hafnium, and tin in the ICO particles (A) (proportion of the total amount of zirconium, hafnium, and tin to metal elements constituting the ICO particles (A)) can be, for example, 0.1 to 3.0 at %, and from the viewpoint of improving the transmittance, the total concentration is preferably 0.1 to 2.0 at % and more preferably 0.2 to 2.0 at %.

In the present invention, the ICO particles (A) are oxides obtained by doping indium oxide with cerium or any element. An indium concentration of the ICO particles (A) can be, for example, 90.0 to 99.5 at %, and is preferably 92.0 to 99.0 at % and more preferably 94.0 to 99.0 at %.

The above-described concentration of the element α of the ICO particles (A) can be adjusted by the concentration of the element α in each precursor solution used for producing the ICO particles (A).

### Average Particle Diameter

An average particle diameter of the ICO particles (A) can be, for example, 5 to 50 nm, and from the viewpoint of improving the transmittance, the average particle diameter is preferably 16 to 30 nm and more preferably 20 to 30 nm. By setting the average particle diameter to the above-described upper limit value or less, it is possible to prevent deterioration of transmittance due to Rayleigh scattering. In addition, by setting the average particle diameter to 5 nm or more, it is possible to perform a production of the ICO particles (A) without technical difficulty. Among these, by setting the average particle diameter to 16 nm or more (more preferably, 20 nm or more), in a case of preparing the curable resin composition according to the embodiment of the present invention, solidification of the composition is unlikely to occur, a filling rate of the ICO particles (A) in the composition can be easily increased, and the wavelength dependence of the refractive index can be improved.

As the ICO particles (A) used in the present invention, among these, from the viewpoint of improving the wavelength dependence of the refractive index and improving the transmittance, oxide nanoparticles which include indium, cerium, and at least one element of tin, zirconium, or hafnium and in which the average particle diameter is 16 to 30 nm are preferable.

The ICO particles (A) used in the present invention can be used as an additive for a lens for adjusting the wavelength dependence of the refractive index.

Hereinafter, a method for measuring and calculating the concentration of the element a of the ICO particles (A) and the average particle diameter will be described collectively. Details of the measurement conditions and the like are as described in Examples described later.

### ICP-MS Analysis

The concentration of the element a of the ICO particles (A) can be measured by Inductively Coupled Plasma Mass Spectrometry (ICP-MS).

### TEM Analysis

The average particle diameter of the ICO particles (A) can be obtained by averaging equivalent circle diameters of primary particles, which are measured by a transmission electron microscope (TEM). That is, an area S of the particles is measured for one particle in the electron micrograph taken by TEM, and a diameter of a perfect circle corresponding to this area S (equivalent circle diameter=2(S/π)^{0.5}) is obtained. The average particle diameter in the present invention is an arithmetic average of equivalent circle diameters obtained for 500 randomly selected particles.

In addition, with regard to a concentration of the element a of the ICO particles (A) or an average particle diameter in a cured product, the particles obtained by dissolving the cured product using an alkali solution or the like can also be measured and calculated by ICP-MS or TEM as described above.

### Production of ICO Particles (A) and Preparation of Composition

The curable resin composition according to the embodiment of the present invention is preferably prepared by mixing ICO particles (A) dispersed in a solvent with a dispersant and a (meth)acrylate compound described later. After mixing, the solvent used for dispersing the ICO particles (A) may or may not be removed from the curable resin composition by distillation or the like, but it is preferable to be removed.

Dispersibility of the ICO particles (A) in a solvent can be improved by using surface-modified ICO particles (A). The surface modification of the ICO particles (A) is preferably performed using, for example, a monocarboxylic acid having 6 to 20 carbon atoms as a surface-modifying compound. The surface modification of the ICO particles (A) with a monocarboxylic acid can be performed by a method in the related art, and it is preferable that a carboxy group derived from the monocarboxylic acid forms an ester bond with an oxygen atom on the surface of the ICO particles (A), or the carboxy group is coordinated with In or Ti atom.

Examples of the monocarboxylic acid having 6 to 20 carbon atoms include oleic acid (having 18 carbon atoms), stearic acid (having 18 carbon atoms), palmitic acid (having 16 carbon atoms), myristic acid (having 14 carbon atoms), and decanoic acid (having 10 carbon atoms), and oleic acid (having 18 carbon atoms) is preferable.

In the curable resin composition, a moiety derived from the surface-modifying compound in the ICO particles (A) (for example, a group derived from a monocarboxylic acid having 6 to 20 carbon atoms) bonded to the ICO particles (A) by the above-described surface modification may be bonded to the ITO particles as it is, a part thereof may be substituted by a group derived from a dispersant described later, or all may be substituted by groups derived from a dispersant described later. In the curable resin composition according to the embodiment of the present invention, it is preferable that both the moiety derived from the surface-modifying compound (for example, a group derived from a monocarboxylic acid having 6 to 20 carbon atoms) and the group derived from the dispersant described later are bonded to the surface of the ICO particles (A).

As the solvent, a solvent, in which a constituent (δp) of a polarity element in a solubility parameter (SP value) is 0 to 6 MPa^{1/2}, is preferable.

The constituent (δp) of the polarity element in the SP value is a value calculated by the Hansen solubility parameter. The Hansen solubility parameter is constituted of intermolecular dispersive force energy (δd), intermolecular polar energy (δp), and intermolecular hydrogen bonding energy (δh). In the present invention, the Hansen solubility parameter is a value calculated using HSPiP (version 4.1.07) software.

Specifically, the solvent is preferably toluene (1.4), xylene (1.0), or hexane (0), and more preferably toluene. The value in the parentheses is a value of δp, and the unit is MPa^{(1/2)}.

A method for producing the ICO particles (A) is not particularly limited, and for example, the ICO particles (A) can be produced according to procedures described in ACS Nano 2016, 10, pp. 6942 to 6951 and Nano Lett. 2016, 16, pp. 3390 to 3398. According to the procedure of the reference, a dispersion liquid of the ICO particles (A) can be obtained, and the surface modification can be performed with reference to the description in the same reference.

Specifically, Specifically, a mixed solution (hereinafter, referred to as a “mixed solution α”) of a monocarboxylic acid having 6 to 20 carbon atoms, an indium salt (for example, indium acetate), and a cerium salt (for example, cerium acetylacetonate) is heated and mixed to form a precursor solution (hereinafter, referred to as a “precursor solution β”), this precursor solution β is added dropwise to an alcohol (long-chain alcohol such as oleyl alcohol) heated to high temperature, the heating is stopped after the reaction is completed, and the mixture is cooled to room temperature.

Thereafter, by centrifuging or adding a poor solvent (lower alcohol such as ethanol) having low polymer solubility, particles are precipitated, the supernatant is removed, and the particles are redispersed in the above-described solvent such as toluene, thereby capable of forming a dispersion liquid of surface-modified ICO particles (A).

Other compounds may be added to the above-described mixed solution a according to the constituent elements of the target ICO particles (A), and for example, a tin salt (for example, tin acetate), a zirconium salt (for example, zirconium acetylacetonate), or a hafnium salt (for example, hafnium acetylacetonate) can be added.

In addition, a blending concentration of each compound in the above-described mixed solution α may be adjusted in accordance with the content proportion of the constituent elements of the target ICO particles (A). The elements such as cerium, zirconium, hafnium, and the like, which have a lower element concentration in the obtained ICO particles (A) with respect to the blending concentration of each element in the above-described mixed solution α, may be blended in consideration of this point.

In the step of heating and mixing the above-described mixed solution α to obtain the precursor solution β, the temperature and time for heating and mixing are not particularly limited as long as a precursor (indium oleate, cerium oleate, and the like) in which a monocarboxylic acid having 6 to 20 carbon atoms is coordinated with indium, cerium, and the like can be obtained.

In the step of adding dropwise the above-described mixed solution α to the alcohol heated to high temperature, the alcohol heating temperature and the dropwise addition rate of the above-described mixed solution a are not particularly limited as long as the target ICO particles (A) can be obtained.

A content proportion of the ICO particles (A) in the curable resin composition according to the embodiment of the present invention is preferably 10% to 70% by mass, more preferably 10% to 60% by mass, and still more preferably 20% to 50% by mass.

### Dispersant

The curable resin composition according to the embodiment of the present invention contains a dispersant for dispersing the ICO particles (A) in the composition.

As the above-described dispersant, a cationic surfactant, an anionic surfactant, or an amphoteric surfactant can be used. By using these dispersants, the ICO particles (A) can be dispersed in the composition.

As the cationic surfactant, it is preferable to have an amine salt type group or a quaternary ammonium salt type group.

As the anionic surfactant, it is preferable to have a carboxy group, a phosphono group (—PO(OH)₂), a phosphonooxy group (phosphoric acid group, —OPO(OH)₂), a hydrohydroxyphosphoryl group (—PH(O)(OH)), a sulfino group (—SO(OH)), a sulfo group (—SO₂(OH)), a sulfanyl group (—SH), or a salt thereof, as an acidic group. The above-described acidic group is more preferably a carboxy group, a phosphono group, a phosphonooxy group, or a salt thereof, and still more preferably a carboxy group or a salt thereof.

Examples of such an anionic surfactant include carboxylic acid type such as a (meth)acrylic acid compound and a hydroxystearic acid compound, phosphoric acid type such as a phosphoric acid compound, sulfonic acid type such as an amido sulfonic acid compound, polycarboxylic acid type such as a poly(meth)acrylic acid, and polyphosphoric acid type anionic surfactants.

Examples of the amphoteric surfactant include amino acid type or betaine type amphoteric surfactants.

An ionic group such as the acidic group in the above-described dispersant functions as the dispersant by exhibiting an adsorption action on the surface of the ICO particles (A) by at least one of an ionic bond, a covalent bond, a hydrogen bond, or a coordinate bond.

Among these, as the above-described dispersant, an anionic surfactant is preferable.

Specific examples of the above-described dispersant include DISPERBYK series (product name, manufactured by BYK Japan KK) of DISPERBYK-106, 108, 110, 111, 118, 140, 142, 145, 161, 162, 163, 164, 167, 168, 180, 2013, 2055, and 2155, and Phosmer series (product name, manufactured by Unichemical Co., Ltd.) of Phosmer M, Phosmer PE, Phosmer MH, and Phosmer PP.

### Acidic Polymer

In addition, preferred examples of the above-described dispersant also include an acidic polymer having the above-described acidic group as an adsorbing group to be adsorbed on the ICO particles (A) (hereinafter, also referred to as an acidic polymer).

The acidic group included in the acidic polymer is preferably a carboxy group or a salt thereof. The acidic polymer including a carboxy group has higher compatibility with a (meth)acrylate compound described later than, for example, a phosphoric acid-based dispersant having a phosphono group or a phosphonooxy group. Therefore, in a case where a curable resin composition including the acidic polymer having a carboxy group is cured, phase separation or whitening hardly occurs. In addition, in a case of forming a diffraction grating shape, adhesiveness between the resin and the mold is good, and asperity of a peeled surface is less likely to occur due to that curing shrinkage is small. Furthermore, the viscosity is less likely to increase as compared with, for example, an amine-based dispersant having an amine salt type group or a quaternary ammonium salt type group.

The above-described acidic polymer preferably includes a (meth)acrylate polymer skeleton consisting of a (meth)acrylate constitutional unit.

By including the (meth)acrylate polymer skeleton, compatibility between the acidic polymer and the (meth)acrylate compound in the curable resin composition can be improved. In addition, it is easy to control the refractive index of the cured product obtained by curing the curable resin composition.

Examples of the above-described (meth)acrylate constitutional unit include a constitutional unit derived from a (meth)acrylate monomer, described in paragraph 0042 of JP2012-107191A, and a constitutional unit represented by General Formula (P) is preferable.

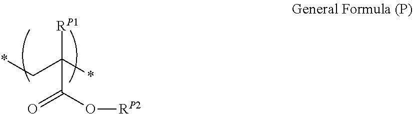

In the formula, R^{P1} represents a hydrogen atom or a methyl group, and R^{P2} represents a monovalent substituent. * represents a bonding portion for incorporation into a polymer main chain.

R^{P2} is preferably an alkyl group or an alicyclic hydrocarbon group, and preferably an alkyl group. The number of carbon atoms in the alkyl group is preferably 1 to 20, more preferably 1 to 12, still more preferably 1 to 8, particularly preferably 1 to 4, and most preferably 1.

From the viewpoint of preventing the viscosity of the curable resin composition from increasing, it is preferable that the methyl group which can be adopted as R^{P1} and the alkyl group and alicyclic hydrocarbon group which can be adopted as R^{P2} do not include the above-described acidic group as a substituent.

The above-described (meth)acrylate polymer skeleton may be linear or branched. Among these, it is preferable to be linear.

The number of (meth)acrylate constitutional units constituting one (meth)acrylate polymer skeleton is preferably 5 to 50, more preferably 8 to 40, and still more preferably 10 to 30.

The number of (meth)acrylate polymer skeletons included in one molecule of the above-described acidic polymer may be 1 or 2 or more, and for example, is preferably 1 to 6 and more preferably 1 to 4.

The above-described acidic polymer preferably has a moiety including an acidic group in at least one terminal side of the above-described (meth)acrylate polymer skeleton. The “having a moiety including an acidic group in at least one terminal side of the (meth)acrylate polymer skeleton” means that it has a moiety including an acidic group, either directly or through a linking group, to at least one terminal of the (meth)acrylate polymer skeleton. By having the moiety including an acidic group in the terminal side of the (meth)acrylate polymer skeleton, it is possible to prevent the viscosity of the curable resin composition from increasing due to the acidic polymer.

The above-described acidic polymer more preferably has the moiety including the above-described acidic group at the terminal of the polymer chain, and still more preferably has the moiety including the acidic group only in the terminal side of any one of the above-described (meth)acrylate polymer skeletons.

In a case where two or more (meth)acrylate polymer skeletons are included in one molecule of the acidic polymer, it is preferable that all (meth)acrylate polymer skeletons have the moiety including an acidic group in at least one terminal side of the (meth)acrylate polymer skeleton, and it is more preferable that all (meth)acrylate polymer skeletons have the moiety including an acidic group only in the terminal side of any one of the (meth)acrylate polymer skeletons.

It is more preferable that the acidic polymer include the acidic group only in the (meth)acrylate polymer skeleton, and it is still more preferable that the above-described (meth)acrylate polymer skeleton is linear and has the moiety including an acidic group only at one terminal thereof. As a result, it is possible to prevent an increase in viscosity of the curable resin composition.

The above-described acidic polymer preferably has a structural portion represented by General Formula (PA) as a structural portion including the above-described acidic group.

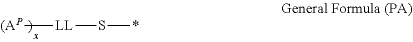

In the formula, A^{P} represents an acidic group, LL represents a single bond or an (x+1)-valent linking group, in which x represents an integer of 1 to 10. * represents a bonding position with the remaining moiety of the acidic polymer.

The acidic group which can be adopted as A^{P} has the same meaning as the acidic group described in the above acidic polymer, and the preferred aspect thereof is also the same.

Examples of the (x+1)-valent linking group which can be adopted as LL include an (x+1)-valent saturated fatty acid hydrocarbon group (group obtained by removing x+1 hydrogen atoms from alkane) and an (x+1)-valent alicyclic hydrocarbon group (group obtained by removing x+1 hydrogen atoms from alicyclic hydrocarbon). In addition, examples thereof include an (x+1)-valent group consisting of a combination of these groups and a bond selected from —O—, —(C═O)—O—, or —(C═O)—NH—.

The number of carbon atoms in the (x+1)-valent saturated fatty acid hydrocarbon group which can be adopted as LL is preferably 1 to 10, more preferably 1 to 7, and still more preferably 1 to 5.

LL is preferably the (x+1)-valent saturated fatty acid hydrocarbon group or a group consisting of a combination of the (x+1)-valent saturated fatty acid hydrocarbon group and —O—.

x is preferably an integer of 2 to 8, more preferably an integer of 2 to 4, and still more preferably an integer of 2.

The structure represented by General Formula (PA) is preferably a structure represented by General Formula (PA1), and from the viewpoint of improving the adsorptivity to the ICO particles (A) by having a carboxy group in the adjacent site, more preferably a structure represented by Formula (PA2).

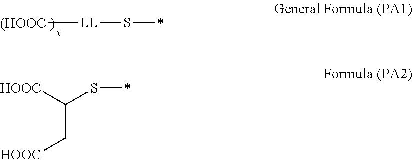

LL and x in the formulae have the same meaning as LL and x in General Formula (PA) described above. * represents a bonding position with the remaining moiety of the acidic polymer.

The number of structures represented by Formula (PA), (PA1), or (PA2) included in the acidic polymer is preferably 1 to 4.

The acid value of the acidic polymer is preferably 2.0 mgKOH/g or more and less than 100 mgKOH/g, and more preferably 2.0 mgKOH/g or more and less than 70 mgKOH/g. The acid value means the number in mg of potassium hydroxide required to neutralize acid components present in 1 g of the acidic polymer.

By adjusting the molecular weight of the acidic polymer and the number of acidic groups such as a carboxy group so that the acid value of the acidic polymer is within the above-described preferred range, it is possible to achieve both appropriate viscosity and particle dispersion performance as the curable resin composition. In a case where the acid value of the acidic polymer is 2.0 mgKOH/g or more, the acidic polymer can be sufficiently adsorbed on and dispersed in the ICO particles (A). In addition, in a case where the acid value of the acidic polymer is less than 100 mgKOH/g, the number and the molecular size of adsorptive groups can be adjusted to prepare the viscosity of the curable resin composition to an appropriate range.

Preferred examples of the acidic polymer include an acidic polymer having a structure represented by General Formula (1).

(R¹—S-L²)ₙ-L¹-(L³-A-R²)ₘ (1)

In the formula, R¹ has the same meaning as -LL-(A^{P})ₓ in General Formula (PA) described above, and A represents the (meth)acrylate polymer skeleton represented by General Formula (P).

R² represents a hydrogen atom or a substituent not including an acidic group, L¹ represents a single bond or an (m+n)-valent linking group, and L² and L³ represent a single bond or a divalent linking group.

m is an integer in a range of 1 to 8, and n is an integer in a range of 1 to 9. However, m+n satisfies 2 to 6.

Preferred examples of R¹ include an alkyl group substituted with a carboxy group, and an alkyl group having 1 to 10 carbon atoms and substituted with 2 to 4 carboxy groups is more preferable, an alkyl group having 1 to 7 carbon atoms and substituted with 2 or 3 carboxy groups is still more preferable, and an alkyl group having 1 to 5 carbon atoms and substituted with 2 carboxy groups is particularly preferable. Among these, the above-described structure represented by Formula (PA2) is preferable.

R² is preferably a hydrogen atom.

Examples of the (m+n)-valent linking group which can be adopted as L¹ include a group formed by removing any (m+n) hydrogen atoms in a linear or branched alkane and the following groups.

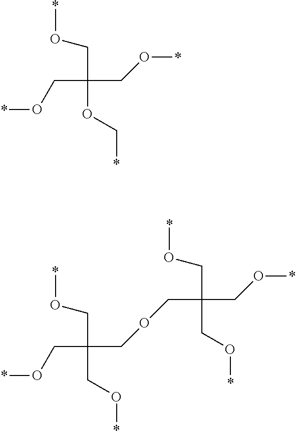 [SMILES: *COC(CO*)(CO*)CO* ; *OCC(CO*)(CO*)COCC(CO*)(CO*)CO*]

Examples of the divalent linking group which can be adopted as L² and L³ include an alkylene group having 1 to 10 carbon atoms, and a group in which, in an alkylene group having 1 to 10 carbon atoms, any one or two or more non-adjacent —CH₂— are substituted with —O—, —S—, —C(═O)—, —OC(═O)—, —C(═O)O—, —OC(═O)O—, —NHC(═O)—, —C(═O)NH—, —OC(═O)NH—, —NHC(═O)O—, —SC(═O)—, or —C(═O)S—.

A weight-average molecular weight of the acidic polymer is preferably 1000 to 20000, more preferably 1000 to 15000, and still more preferably 1000 to 7000. By setting the weight-average molecular weight of the polymer dispersant to 1000 or more, it is possible to suppress mixing of bubbles generated during curing the curable resin composition. In addition, by setting the weight-average molecular weight of the polymer dispersant to the above-described preferred upper limit value or less, the fluidity is less likely to decrease even in a case where an amount necessary for dispersing the ICO particles (A) is added to the curable resin composition, and even in a case of forming a diffraction grating shape, air is less likely to enter the step of the mold and gaps are less likely to occur.

Specific examples of the acidic polymer include compounds having the following structures. In the following structural formulae, one terminal (R² in General Formula (1)) of the (meth)acrylate polymer skeleton is a hydrogen atom. m and n have the same meaning as m and n in the General Formula (1) described above.

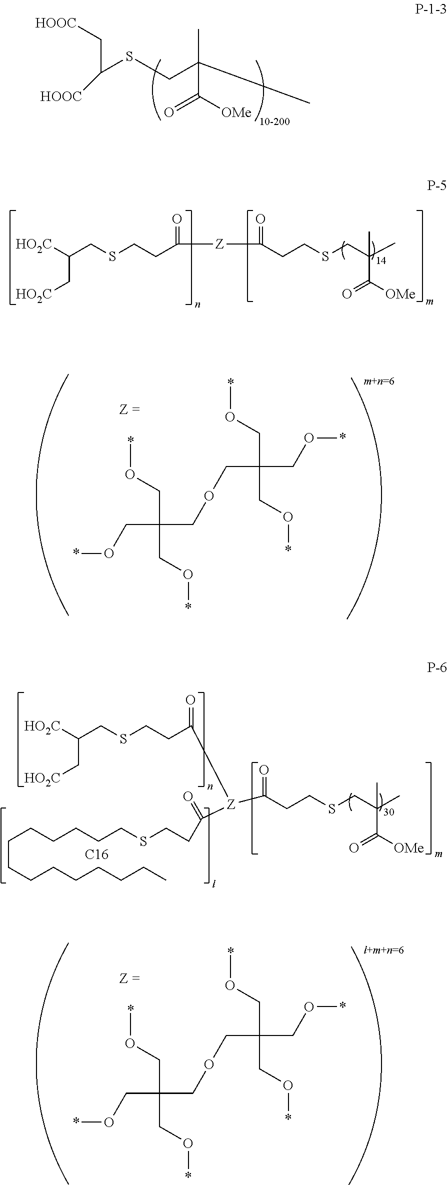

The above-described polymer dispersant can be produced by a conventional method. For example, the polymer dispersant can be produced by a reaction between a (meth)acrylate monomer and a compound capable of terminating the polymerization reaction of this monomer and having an acidic group. Examples of such compounds include mercaptosuccinic acid, mercaptooxalic acid, and mercaptomalonic acid, and mercaptosuccinic acid is preferable. Furthermore, a structure having a plurality of the (meth)acrylate polymer skeletons in one molecule can be obtained by adding and reacting a polyol mercapto alkylate or the like. In addition, with regard to a polymer dispersant having a phosphonooxy group at one terminal, a method described in JP1994-20261A (JP-H6-20261A) can be referred to.

In the curable resin composition, a content of the acidic polymer is preferably 5 to 50 parts by mass, more preferably 5 to 30 parts by mass, still more preferably 5 to 25 parts by mass, and particularly preferably 5 to 20 parts by mass with respect to 100 parts by mass of the content of the ICO particles (A). By setting the content ratio to the above-described preferred range, it is possible to suppress the mixing of bubbles generated during curing while stably dispersing the ICO particles (A) in the curable resin composition.

### (Meth)Acrylate Compound

The curable resin composition according to the embodiment of the present invention contains a monofunctional or higher functional (meth)acrylate compound. The monofunctional or higher functional (meth)acrylate compound means a compound having one or more (meth)acryloyl groups as a functional group, and in the present invention, is also simply referred to as a “(meth)acrylate compound”. In the curable resin composition according to the embodiment of the present invention, the ICO particles (A) can be dispersed in a medium including the (meth)acrylate compound by a dispersant, and a cured product in which the ICO particles (A) are dispersed in a resin including the (meth)acrylate compound as a constituent component can be obtained from the curable resin composition according to the embodiment of the present invention.

The (meth)acrylate compound may be monofunctional or higher functional, and the number of functional groups is not particularly limited and can be, for example, 8 or less.

Specific examples of the monofunctional or bifunctional (meth)acrylate compound include the following monomer 1 (phenoxyethyl acrylate), monomer 2 (benzyl acrylate), monomer 3 (tricyclodecanedimethanol diacrylate), and monomer 4 (dicyclopentanyl acrylate). In addition, specific examples thereof include M-1 (1,6-hexanediol diacrylate), M-2 (1,6-hexanediol dimethacrylate), M-3 (benzyl acrylate), M-4 (isobornyl methacrylate), M-5 (dicyclopentanyl methacrylate), M-6 (dodecyl methacrylate), M-7 (2-ethylhexyl methacrylate), M-8 (2-hydroxyethyl acrylate), M-9 (hydroxypropyl acrylate), and M-10 (4-hydroxybutyl acrylate).

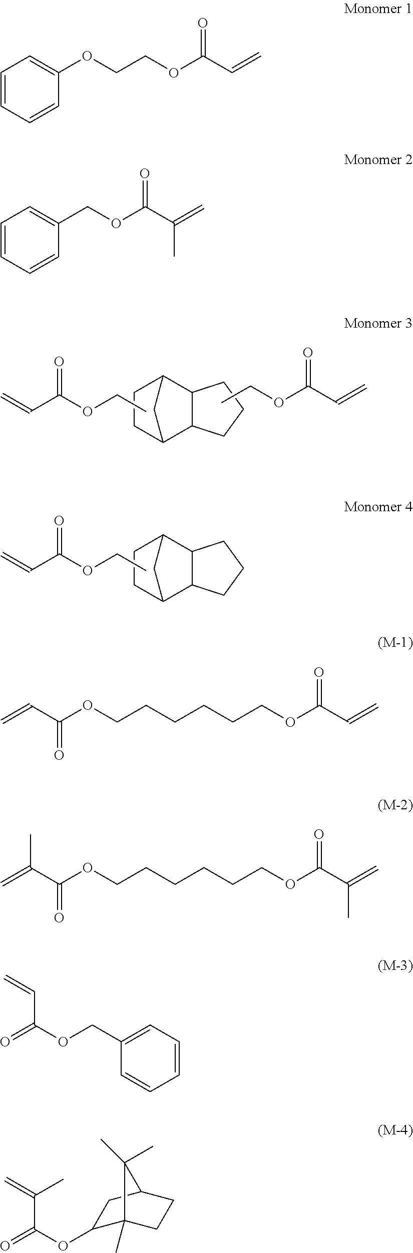

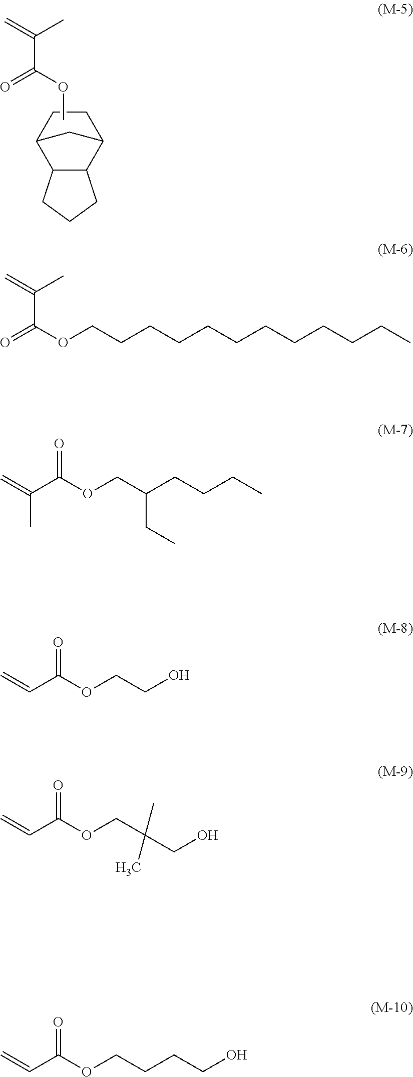

A method for obtaining the (meth)acrylate compound is not particularly limited, and the (meth)acrylate compound may be obtained commercially or may be synthesized by a conventional method.

In a case of being obtained commercially, for example, Viscoat #192 PEA (monomer 1 described above) (manufactured by OSAKA ORGANIC CHEMICAL INDUSTRY LTD.), Viscoat #160 BZA (monomer 2 described above) (manufactured by OSAKA ORGANIC CHEMICAL INDUSTRY LTD.), Lightester Bz (monomer 2 described above) (manufactured by KYOEISHA CHEMICAL Co., LTD.), A-DCP (monomer 3 described above) (manufactured by Shin-Nakamura Chemical Co., Ltd.), FA-513AS (monomer 4 described above) (manufactured by Hitachi Chemical Co., Ltd.), A-HD-N (M-1 described above) (manufactured by Shin-Nakamura Chemical Co., Ltd.), HD-N (M-2 described above) (manufactured by Shin-Nakamura Chemical Co., Ltd.), FA-BZA (M-3 described above) (manufactured by Hitachi Chemical Co., Ltd.), Lightester IB-X (M-4 described above) (manufactured by KYOEISHA CHEMICAL Co., LTD.), FA-513M (M-5 described above) (manufactured by Hitachi Chemical Co., Ltd.), Lightester L (M-6 described above) (manufactured by KYOEISHA CHEMICAL Co., LTD.), 2EHA (M-7 described above) (manufactured by TOAGOSEI CO., LTD.), HEA (M-8 described above) (manufactured by OSAKA ORGANIC CHEMICAL INDUSTRY LTD.), Lightester HOP-A(N) (M-9 described above) (manufactured by KYOEISHA CHEMICAL Co., LTD.), or 4-HBA (M-10 described above) (manufactured by OSAKA ORGANIC CHEMICAL INDUSTRY LTD.) can be preferably used.

In addition, in a case where it is necessary to increase the hardness and rub resistance of the surface of the cured product, the curable resin composition preferably includes a polyfunctional (meth)acrylate compound having three or more (meth)acryloyl groups in the molecule. By including a polyfunctional (meth)acrylate compound having three or more (meth)acryloyl groups in the molecule, crosslinking density of the cured product can be effectively improved, so that the surface hardness and rub resistance can be increased while maintaining a high partial dispersion ratio. The upper limit of the number of (meth)acryloyl groups in the polyfunctional (meth)acrylate compound having three or more (meth)acryloyl groups in the molecule is not particularly limited, but is preferably 8 or less and more preferably 6. In a case of being obtained commercially, for example, A-TMPT (monomer 5), A-TMMT (monomer 6), AD-TMP (monomer 7), and A-DPH (monomer 8) (all manufactured by Shin-Nakamura Chemical Co., Ltd.) can be preferably used.

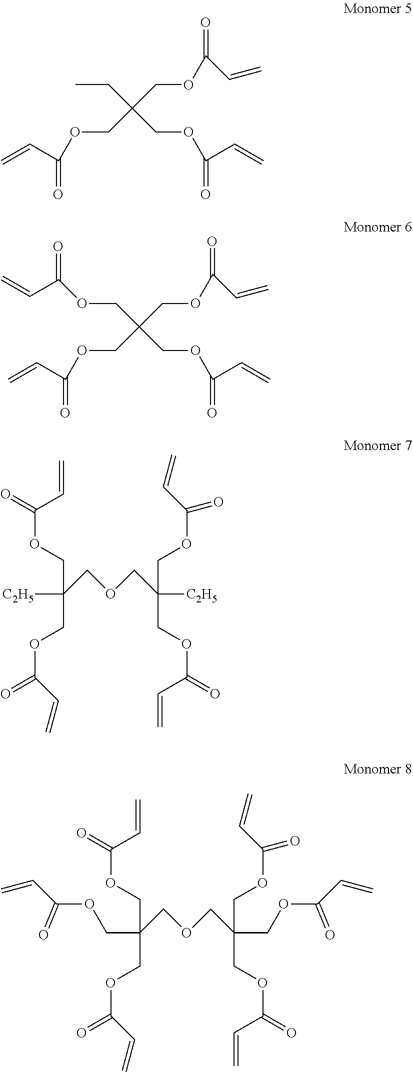

In addition to the above, examples thereof include (meth)acrylate monomers described in paragraphs 0037 to 0046 of JP2012-107191A.

A molecular weight of the (meth)acrylate compound is preferably 100 to 500.

A content of the (meth)acrylate compound in the curable resin composition according to the embodiment of the present invention is preferably 1% to 60% by mass, more preferably 2% to 50% by mass, and still more preferably 3% to 50% by mass. The amount of (meth)acrylate compound in the curable resin composition can be adjusted to adjust the function of the cured product to relieve stress in a case of thermal change.

In particular, in a case where it is necessary to increase the surface hardness and rub resistance of the cured product, the curable resin composition includes the polyfunctional (meth)acrylate compound having three or more (meth)acryloyl groups in the molecule in an amount of preferably 5% to 50% by mass, more preferably 10% to 45% by mass, and still more preferably 25% to 40% by mass with respect to the total mass (in a case of including a solvent, a mass of solid content excluding the solvent) of the curable resin composition.

### Other Components

The curable resin composition according to the embodiment of the present invention may include other components in addition to the ICO particles (A), the dispersant, and the (meth)acrylate compound. Specific examples of the other components include the following polymerization initiator. In addition, a polymer described in paragraphs [0099] to [0108] of WO2020/171197A may be contained.

### Polymerization Initiator

The curable resin composition according to the embodiment of the present invention preferably includes, as the polymerization initiator, at least one selected from a thermal radical polymerization initiator or a photoradical polymerization initiator.

### Thermal Radical Polymerization Initiator

The curable resin composition according to the embodiment of the present invention also preferably includes a thermal radical polymerization initiator. By the action of this thermal radical polymerization initiator, a cured product having high heat resistance can be molded by thermally polymerizing the curable resin composition.

As the thermal radical polymerization initiator, a compound usually used as a thermal radical polymerization initiator can be appropriately used according to conditions of a thermopolymerization (heat curing) step described later. Examples thereof include organic peroxides, and specifically, the following compounds can be used.

Examples thereof include 1,1-di(t-hexylperoxy) cyclohexane, 1,1-di(t-butylperoxy) cyclohexane, 2,2-di(4,4-di-(t-butylperoxy)cyclohexyl) propane, t-hexylperoxyisopropyl monocarbonate, t-butylperoxy-3,5,5-trimethylhexanoate, t-butylperoxylaurate, dicumyl peroxide, di-t-butyl peroxide, t-butylperoxy-2-ethylhexanoate, t-hexylperoxy-2-ethylhexanoate, cumene hydroperoxide, t-butyl hydroperoxide, t-butylperoxy-2-ethylhexyl, and 2,3-dimethyl-2,3-diphenylbutane.

In a case of including a thermal radical polymerization initiator, a content of the thermal radical polymerization initiator in the curable resin composition according to the embodiment of the present invention is preferably 0.01% to 10% by mass, more preferably 0.05% to 5.0% by mass, and still more preferably 0.05% to 2.0% by mass.

### Photoradical Polymerization Initiator

The curable resin composition according to the embodiment of the present invention preferably includes a photoradical polymerization initiator. As the photoradical polymerization initiator, a compound usually used as a photoradical polymerization initiator can be appropriately used according to conditions of a photopolymerization (photocuring) step described later, and specifically, the following compounds can be used.

Examples thereof include bis(2,6-dimethoxybenzoyl)-2,4,4-trimethylpentyl phosphine oxide, bis(2,6-dimethylbenzoyl)-2,4,4-trimethylpentyl phosphine oxide, bis(2,4,6-trimethylbenzoyl)-2,4,4-trimethylpentyl phosphine oxide, bis(2,6-dichlorobenzoyl)-2,4,4-trimethylpentyl phosphine oxide, 1-phenyl-2-hydroxy-2-methylpropan-1-one, 1-hydroxycyclohexylphenylketone, 1-(4-isopropylphenyl)-2-hydroxy-2-methylpropan-1-one, 1,2-diphenylethanedione, methylphenyl glyoxylate, 1-[4-(2-hydroxyethoxy)-phenyl]-2-hydroxy-2-methyl-1-propan-1-one, 2-hydroxy-1-{4-[4-(2-hydroxy-2-methyl-propionyl)-benzyl]phenyl}-2-methyl -propan-1-one, 2,2-dimethoxy-1,2-diphenylethan-1-one, 2-methyl-1-(4-methylthiophenyl)-2-morpholinopropan-1-one, 2-benzyl-2-dimethylamino-1-(4-morpholinophenyl)-1-butanone-2,4,6-trimethylbenzoyl-diphenyl-phosphine oxide, and bis(2,4,6-trimethylbenzoyl)-phenylphosphine oxide.

Among these, in the present invention, as the photoradical polymerization initiator, 1-hydroxycyclohexylphenylketone (for example, Irgacure 184 (product name) manufactured by BASF), bis(2,4,6-trimethylbenzoyl)-phenylphosphine oxide (for example, Irgacure 819 (product name) manufactured by BASF), 2,4,6-trimethylbenzoyl-diphenyl-phosphinoxide (for example, Irgacure TPO (product name) manufactured by BASF), 2,2,-dimethoxy-1,2-diphenylethan-1-one (for example, Irgacure 651 (product name) manufactured by BASF), 1-[4-(2-hydroxyethoxy)-phenyl]-2-hydroxy-2-methyl-1-propan-1-one, or 2-methyl-1-(4-methylthiophenyl)-2-morpholinopropan-1-one can be preferably used.

In a case of including a photoradical polymerization initiator, a content of the photoradical polymerization initiator in the curable resin composition according to the embodiment of the present invention is preferably 0.01% to 5.0% by mass, more preferably 0.05% to 1.0% by mass, and still more preferably 0.05% to 0.5% by mass.

The curable resin composition according to the embodiment of the present invention preferably includes both the photoradical polymerization initiator and the thermal radical polymerization initiator. In this case, the total content of the photoradical polymerization initiator and the thermal radical polymerization initiator in the above-described curable resin composition is preferably 0.01% to 5% by mass, more preferably 0.05% to 1.0% by mass, and still more preferably 0.05% to 0.5% by mass.

### Other Additives and the Like

The curable resin composition according to the embodiment of the present invention may include additives such as a polymer or a monomer other than the above-described components, a dispersant, a plasticizer, a heat stabilizer, a release agent, or the like within a range where the effects of the present invention are exhibited.

### Properties and the Like of Curable Resin Composition

A viscosity of the curable resin composition according to the embodiment of the present invention is preferably 5000 mPa·s or less, more preferably 3000 mPa·s or less, still more preferably 2500 mPa·s or less, and particularly preferably 2000 mPa·s or less. By setting the viscosity of the curable resin composition within the above-described range, handleability in a case of molding a cured product can be improved, and a cured product having high quality can be formed. The viscosity of the curable resin composition is preferably 50 mPa·s or more, more preferably 100 mPa·s or more, still more preferably 200 mPa·s or more, and particularly preferably 500 mPa·s or more.

### Use of Curable Resin Composition

The use of the curable resin composition according to the embodiment of the present invention is not particularly limited, but is it preferably used as a material for producing a diffractive optical element. In particular, among a layer of low refractive index and a layer of high refractive index in the multilayer diffractive optical element, the curable resin composition according to the embodiment of the present invention is used as a material for producing the layer of low refractive index (diffractive optical element having a low refractive index and large wavelength dispersion of the refractive index), which can impart excellent diffraction efficiency.

### Cured Product

The cured product according to an embodiment of the present invention is formed from the curable resin composition according to the embodiment of the present invention. The cured product is obtained by polymerizing a polymerizable compound such as a (meth)acrylate compound. The cured product according to the embodiment of the present invention may include an unreacted monomer.

The cured product obtained by curing the curable resin composition according to the embodiment of the present invention is transparent from the near-infrared wavelength region to the shortwave infrared wavelength region (approximately 800 to 1600 nm), and a refractive index at a wavelength of 852 nm and a refractive index at a wavelength of 1530 nm are both low as described later.

For example, in a case where the cured product is formed as a sheet having a thickness of 6 μm, a value of 90% or more can be obtained as a transmittance at the wavelength of 852 nm and a value of 40% or more, preferably 50% or more and more preferably 60% or more, can be obtained as a transmittance at the wavelength of 1650 nm. Here, the transmittance means a value measured using a spectrophotometer (for example, a spectrophotometer “V-670” manufactured by JASCO Corporation).

A refractive index of the cured product obtained by curing the curable resin composition according to the embodiment of the present invention at the wavelength of 852 nm is preferably 1.500 to 1.650 and more preferably 1.500 to 1.600.

A refractive index of the cured product obtained by curing the curable resin composition according to the embodiment of the present invention at the wavelength of 1530 nm is preferably 1.300 to 1.550, more preferably 1.350 to 1.550, and still more preferably 1.400 to 1.510.

A value obtained by subtracting the refractive index of the cured product obtained by curing the curable resin composition according to the embodiment of the present invention at the wavelength of 1530 nm from the refractive index of the cured product obtained by curing the curable resin composition according to the embodiment of the present invention at the wavelength of 852 nm is preferably 0.010 to 0.100, and more preferably 0.030 to 0.100.

In the present invention, the refractive index means a value measured by using ellipsometry, and for example, can be measured with reference to a method described in Examples later.

The refractive index in the present invention is a value obtained by rounding off the fourth decimal point of the measured refractive index.

A birefringence Δn of the cured product of the curable resin composition according to the embodiment of the present invention (in the present invention, also referred to as a birefringence Δn(587 nm)) at a wavelength of 587 nm is preferably 0.00≤Δn≤0.01. The birefringence Δn(587 nm) is more preferably 0.001 or less and still more preferably less than 0.001. The lower limit value of the birefringence Δn(587 nm) may be 0.00001 or 0.0001.

The birefringence Δn(587 nm) of the cured product can be obtained by the following method. A film-shaped sample is produced, and using a birefringence evaluation device (for example, product name: WPA-100, manufactured by Photonic Lattice, Inc.), a birefringence within a 10 mm diameter circle including the center of the sample is measured. Thereafter, the birefringence Δn(587 nm) can be obtained by obtaining the average value of birefringence at a wavelength of 587 nm.

### Method for Producing Cured Product

The cured product according to the embodiment of the present invention can be produced by photocuring the curable resin composition according to the embodiment of the present invention by light irradiation, or by heat-curing the curable resin composition according to the embodiment of the present invention by heating. It is preferable that the above-described photoradical polymerization initiator is contained in the curable resin composition in a case of photocuring, or the above-described thermal radical polymerization initiator is contained in the curable resin composition in a case of heat-curing.

As for the photocuring conditions, a description of light irradiation in a diffractive optical element described later can be preferably applied.

In the heat curing, the heating temperature can be, for example, 150° C. or higher, and is preferably 160° C. to 270° C., more preferably 165° C. to 250° C., and still more preferably 170° C. to 230° C. During heating, pressurization may be performed together with the heating. The pressure in a case of pressurization is preferably 0.098 MPa to 9.8 MPa, more preferably 0.294 MPa to 4.9 MPa, and still more preferably 0.294 MPa to 2.94 MPa.

The heat-curing time is preferably 30 to 1000 seconds, more preferably 30 to 500 seconds, and still more preferably 60 to 300 seconds. The atmosphere during the heat curing (thermopolymerization) is preferably an atmosphere replaced with air or an inert gas, and more preferably an atmosphere in which air is replaced with nitrogen until the oxygen concentration is 1% or less.

### Diffractive Optical Element

The diffractive optical element according to an embodiment of the present invention is a diffractive optical element including a surface which has a diffraction grating shape and is formed of the cured product according to the embodiment of the present invention, and is formed by curing the curable resin composition according to the embodiment of the present invention.

The diffractive optical element according to the embodiment of the present invention preferably has a maximum thickness of 2 μm to 100 μm. The maximum thickness is more preferably 2 μm to 50 μm and still more preferably 2 μm to 30 μm. In addition, a level difference (lattice thickness) of the diffraction grating shape (periodic structure) included in the diffractive optical element is preferably 1 μm to 100 μm and more preferably 1 μm to 50 μm. Furthermore, it is sufficient that a pitch of the diffraction grating shape included in the diffractive optical element is in a range of 0.1 mm to 10 mm, and it is preferable that the pitch is changed according to the required optical aberration in the same diffractive optical element.

The diffractive optical element can be produced according to, for example, the following procedure.

The curable resin composition is sandwiched between a surface of a mold, which is processed into a diffraction grating shape, and a transparent substrate. Thereafter, the curable resin composition may be pressurized and stretched to a desired range. In the sandwiched state, the curable resin composition is irradiated with light from the transparent substrate side to cure the curable resin composition. Thereafter, the cured product is released from the mold. After the mold release, the cured product may be further irradiated with light from the side opposite to the transparent substrate side.

Examples of the transparent substrate include a flat glass, and a flat transparent resin (such as (meth)acrylic resin, polycarbonate resin, and polyethylene terephthalate).

The transparent substrate used in the above-described production may be included in the diffractive optical element as it is, or may be peeled off

The surface of the mold, which is processed into a diffraction grating shape, is preferably a chromium nitride-treated surface. As a result, good mold releasability can be obtained, and the producing efficiency of the diffractive optical element can be improved.

Examples of the chromium nitride treatment include a method for forming a chromium nitride film on the mold surface. As the method for forming a chromium nitride film on the mold surface, a chemical vapor deposition (CVD) method and a physical vapor deposition (PVD) method can be exemplified. The CVD method is a method in which a raw material gas including chromium and a raw material gas including nitrogen are reacted at a high temperature to form a chromium nitride film on a surface of a base substance. In addition, the PVD method is a method (arc-type vacuum vapor deposition method) for forming a chromium nitride film on a surface of a base substance using arc discharge. The arc-type vacuum vapor deposition method is a method for forming a film of a compound by reacting ionized metals with a reaction gas on the surface of the base substance. Specifically, a cathode (evaporation source) formed with, for example, chromium in a vacuum container, is disposed, arc discharge occurs between the cathode and a wall surface of the vacuum container through a trigger, ionization of metal by arc plasma is performed at the same time of evaporating the cathode, a negative voltage is applied to the base substance, and a reaction gas (for example, nitrogen gas) is introduced into the vacuum container at approximately several tens mTorr (1.33 Pa).

As the light used for the light irradiation curing the curable resin composition, ultraviolet rays or visible rays are preferable and ultraviolet rays are more preferable. For example, a metal halide lamp, a low pressure mercury lamp, a high pressure mercury lamp, an ultra-high pressure mercury lamp, a germicidal lamp, a xenon lamp, a light emitting diode (LED) light source lamp, and the like are suitably used. The illuminance of ultraviolet light used for the light irradiation curing the curable resin composition is preferably 1 to 100 mW/cm², more preferably 1 to 75 mW/cm², and still more preferably 5 to 50 mW/cm². The curable resin composition may be irradiated with ultraviolet light having different illuminance multiple times. The exposure amount of ultraviolet light is preferably 0.4 to 10 J/cm², more preferably 0.5 to 5 J/cm², and still more preferably 1 to 3 J/cm². The atmosphere during the light irradiation is preferably an atmosphere replaced with air or an inert gas, and more preferably an atmosphere in which air is replaced with nitrogen until the oxygen concentration is 1% or less.

### Multilayer Diffractive Optical Element

The multilayer diffractive optical element according to an embodiment of the present invention includes a first diffractive optical element and a second diffractive optical element, in which the first diffractive optical element is a diffractive optical element formed of the cured product according to the embodiment of the present invention, and the surface of the first diffractive optical element, which has a diffraction grating shape, and a surface of the second diffractive optical element, which has a diffraction grating shape, face each other. It is preferable that the surfaces having the diffraction grating shapes are in contact with each other.

It is preferable that a multilayer diffractive optical element is formed by including, as a first diffractive optical element, the diffractive optical element formed by curing the curable resin composition according to the embodiment of the present invention, and further overlapping a second diffractive optical element formed of a different material such that the first diffractive optical element and the second diffractive optical element face each other in lattice-shaped surfaces. In this case, it is preferable that the lattice-shaped surfaces are in contact with each other.

By forming the second diffractive optical element with a material having a higher refractive index and smaller wavelength dispersion of refractive index than the first diffractive optical element, it is possible to suppress the occurrence of flare, and the like, and sufficiently utilize a chromatic aberration reducing effect of the multilayer diffractive optical element.

A refractive index of the second diffractive optical element at the wavelength of 852 nm (hereinafter, also abbreviated as “n852”) is preferably 1.550 to 1.700 and more preferably 1.560 to 1.650. In addition, the refractive index of the second diffractive optical element at the wavelength of 852 nm is larger than the refractive index of the first diffractive optical element simultaneously used in the multilayer diffractive optical element, that is, it is satisfied that the refractive index of the second diffractive optical element at the wavelength of 852 nm>the refractive index of the first diffractive optical element at the wavelength of 852 nm.

A refractive index of the second diffractive optical element at the wavelength of 1530 nm (hereinafter, also abbreviated as “n1530”) is preferably 1.550 to 1.700 and more preferably 1.560 to 1.650. In addition, the refractive index of the second diffractive optical element at the wavelength of 1530 nm is larger than the refractive index of the first diffractive optical element simultaneously used in the multilayer diffractive optical element, that is, it is satisfied that the refractive index of the second diffractive optical element at the wavelength of 1530 nm>the refractive index of the first diffractive optical element at the wavelength of 1530 nm.

A value (hereinafter, also abbreviated as “n852−n1530”) obtained by subtracting the refractive index of the second diffractive optical element at the wavelength of 1530 nm from the refractive index of the second diffractive optical element at the wavelength of 852 nm is preferably 0.010 or less and more preferably 0.005 or less. In addition, n852−n1530 of the second diffractive optical element is smaller than n852−n1530 of the first diffractive optical element used simultaneously in the multilayer diffractive optical element, that is, “n852−n1530 of second diffractive optical element”<“n852−n1530 of first diffractive optical element” is satisfied.

The material for forming the second diffractive optical element is not particularly limited as long as a cured product having a high refractive index and a small wavelength dispersion of the refractive index is obtained. For example, a curable resin composition including a (meth)acrylate monomer having a sulfur atom, a halogen atom, an aromatic ring structure, a curable resin composition including zirconium oxide and a (meth)acrylate monomer, and the like can be used.

The multilayer diffractive optical element can be produced according to, for example, the following procedure.

A material for forming the second diffractive optical element is sandwiched between a diffraction grating shape surface (surface obtained after the mold release) of a diffractive optical element formed by curing the curable resin composition according to the embodiment of the present invention, and a transparent substrate. Thereafter, the material may be pressurized and stretched to a desired range. In the sandwiched state, the material is irradiated with light from the transparent substrate side to cure the material. Thereafter, the cured product is released from the mold.

That is, as the multilayer diffractive optical element according to the embodiment of the present invention, it is preferable that the first diffractive optical element, the second diffractive optical element, and the transparent substrate are arranged in this order.

Examples of the transparent substrate include the same examples as the transparent substrate used in a case of producing the diffractive optical element (first diffractive optical element).

The transparent substrate used in the above-described production may be included in the multilayer diffractive optical element as it is, or may be peeled off.

The multilayer diffractive optical element preferably has a high diffraction efficiency. For example, a diffraction efficiency of the multilayer diffractive optical element with the primary light at the wavelength of 852 nm is preferably 85% or more and more preferably 95% or more. In addition, a diffraction efficiency of the multilayer diffractive optical element with the primary light at the wavelength of 1530 nm is preferably 85% or more, more preferably 90% or more, and still more preferably 95% or more.

In a case where the diffraction efficiency of the multilayer diffractive optical element with the primary light exhibits high diffraction efficiency at the above-described wavelengths of 852 nm and 1530 nm, unnecessary diffracted light can be sufficiently suppressed, and a high-performance lens excellent in chromatic aberration reducing effect can be realized.

The multilayer diffractive optical element preferably has a maximum thickness of 50 μm to 20 mm. The maximum thickness is more preferably 50 μm to 10 mm and particularly preferably 50 μm to 3 mm.

### Lens

The diffractive optical element and multilayer diffractive optical element according to the embodiments of the present invention can be used as a lens, respectively.

A film or a member can be provided on the surface or the periphery of the lens depending on the environment in which the lens is used or the use of the lens. For example, a protective film, an anti-reflection film, a hard coat film, and the like can be formed on the surface of the lens. In addition, the lens can be used as a composite lens in which a glass lens or a plastic lens is laminated on the lens. Furthermore, the periphery of the lens can be fitted into a base material holding frame or the like, and fixed.

However, these films, frames, and the like are members added to the lens, and are distinguished from the lens itself in the present specification.

The lens is preferably used as an image pick-up lens in a mobile phone, a digital camera, and the like, an imaging lens in a television, a video camera, and the like, and an in-vehicle lens.

### Examples

Hereinafter, the present invention will be described in more detail based on Examples. The materials, amounts used, proportions, treatment details, treatment procedures, and the like described in the following examples can be appropriately modified as long as the gist of the invention is maintained. Therefore, the scope of the present invention should not be construed as being limited to the following specific examples. In the present invention, “room temperature” means 25° C.

### Synthesis Example

Oxide nanoparticles and a dispersant were synthesized as follows.

### 1. Synthesis of Oxide Nanoparticles

### (1) Synthesis of In—Ce—Sn—O Nanoparticles (ITCO-01)

First, 420 ml of oleic acid (manufactured by FUJIFILM Wako Pure Chemical Corporation), 57.508 g of indium acetate (manufactured by Alfa Aesar), 4.777 g of cerium acetylacetonate (manufactured by Sigma-Aldrich Co., LLC), and 0.745 g of tin (IV) acetate (manufactured by Alfa Aesar) were charged into a flask, and the mixture was heated at 160° C. for 2 hours in an environment of nitrogen flow to obtain a yellow transparent precursor solution A having a cerium concentration of 5.2 at % and a tin concentration of 1 at %. Approximately 100 ml of the prepared precursor solution A was filled in a gas tight syringe.

Subsequently, 52 ml of oleyl alcohol (manufactured by FUJIFILM Wako Pure Chemical Corporation) was charged into another flask, and heated at 290° C. in a nitrogen flow. 88 ml of the above-described precursor solution A which had been filled in the gas tight syringe was added dropwise to the heated solvent at a rate of 1.4 ml/min using a syringe pump. After the dropwise addition of the precursor solution A was completed, the heating was stopped, and the mixture was cooled to room temperature.

The obtained reaction solution was subjected to centrifugation so as to remove the supernatant, and redispersed in toluene. Thereafter, the series of operations of addition of ethanol, centrifugation, removal of the supernatant, and redispersion with toluene were repeated three times to obtain 68 ml of a toluene dispersion liquid of oleic acid-coordinated In—Ce—Sn—O nanoparticles (ITCO-01).

The average particle diameter of the above-described ITCO particles by TEM analysis was 21 nm. In addition, in a case where a molar ratio of the constituent elements (metal elements) was measured by ICP-MS analysis, In:Ce:Sn=97.6:1.0:1.4.

### (2) Synthesis of ITO Nanoparticles (ITO-01)

420 mL of oleic acid, 60.451 g of indium acetate, and 1.043 g of tin (IV) acetate were charged into a flask, and the mixture was heated at 160° C. for 2 hours under an environment of nitrogen flow to obtain a yellow transparent precursor solution B having a tin concentration of 1.4 at %. Approximately 100 ml of the prepared precursor solution B was filled in a gas tight syringe.

68 ml of a toluene dispersion liquid of oleic acid-coordinated In—Sn—O (ITO-01) was obtained in the same manner as in the above-described synthesis of (ITCO-01), except that the precursor solution B was used instead of the precursor solution A.

The average particle diameter of the above-described ITO particles by TEM analysis was 21 nm. In addition, in a case where a molar ratio of the constituent elements (metal elements) was measured by ICP-MS analysis, In:Sn=98.6:1.4.

### (3) Synthesis of In—Ce—O Nanoparticles (ICO-01)

First, 420 ml of oleic acid (manufactured by FUJIFILM Wako Pure Chemical Corporation), 58.121 g of indium acetate (manufactured by Alfa Aesar), and 4.777 g of cerium acetylacetonate (manufactured by Sigma-Aldrich Co., LLC) were charged into a flask, and the mixture was heated at 160° C. for 2 hours in an environment of nitrogen flow to obtain a yellow transparent precursor solution C having a cerium concentration of 5.2 at %. Approximately 100 ml of the prepared precursor solution C was filled in a gas tight syringe.

68 ml of a toluene dispersion liquid of oleic acid-coordinated In—Ce—O (ICO-01) was obtained in the same manner as in the above-described synthesis of (ITCO-01), except that the precursor solution C was used instead of the precursor solution A.

The average particle diameter of the above-described ICO particles by TEM analysis was 21 nm. In addition, in a case where a molar ratio of the constituent elements (metal elements) was measured by ICP-MS analysis, In:Ce=98.8:1.2.

### (4) Synthesis of In—Ce—Sn—O Nanoparticles (ITCO-02)

First, 420 ml of oleic acid (manufactured by FUJIFILM Wako Pure Chemical Corporation), 53.339 g of indium acetate (manufactured by Alfa Aesar), 11.023 g of cerium acetylacetonate (manufactured by Sigma-Aldrich Co., LLC), and 0.745 g of tin (IV) acetate (manufactured by Alfa Aesar) were charged into a flask, and the mixture was heated at 160° C. for 2 hours in an environment of nitrogen flow to obtain a yellow transparent precursor solution D having a cerium concentration of 12 at % and a tin concentration of 1 at %. Approximately 100 ml of the prepared precursor solution D was filled in a gas tight syringe.

68 ml of a toluene dispersion liquid of oleic acid-coordinated In—Ce—Sn—O nanoparticles (ITCO-02) was obtained in the same manner as in the above-described synthesis of (ITCO-01), except that the precursor solution D was used instead of the precursor solution A.

The average particle diameter of the above-described ITCO particles by TEM analysis was 21 nm. In addition, in a case where a molar ratio of the constituent elements (metal elements) was measured by ICP-MS analysis, In:Ce:Sn=95.3:3.4:1.3.

### (5) Synthesis of In—Ce—Sn—O Nanoparticles (ITCO-03)

First, 420 ml of oleic acid (manufactured by FUJIFILM Wako Pure Chemical Corporation), 58.183 g of indium acetate (manufactured by Alfa Aesar), 2.388 g of cerium acetylacetonate (manufactured by Sigma-Aldrich Co., LLC), and 1.863 g of tin (IV) acetate (manufactured by Alfa Aesar) were charged into a flask, and the mixture was heated at 160° C. for 2 hours in an environment of nitrogen flow to obtain a yellow transparent precursor solution E having a cerium concentration of 2.6 at % and a tin concentration of 2.5 at %. Approximately 100 ml of the prepared precursor solution E was filled in a gas tight syringe.

68 ml of a toluene dispersion liquid of oleic acid-coordinated In—Ce—Sn—O nanoparticles (ITCO-03) was obtained in the same manner as in the above-described synthesis of (ITCO-01), except that the precursor solution E was used instead of the precursor solution A.

The average particle diameter of the above-described ITCO particles by TEM analysis was 21 nm. In addition, in a case where a molar ratio of the constituent elements (metal elements) was measured by ICP-MS analysis, In:Ce:Sn=96.9:0.7:2.4.

### (6) Synthesis of In—Ce—Zr—O Nanoparticles (IZCO-01)

First, 420 ml of oleic acid (manufactured by FUJIFILM Wako Pure Chemical Corporation), 56.895 g of indium acetate (manufactured by Alfa Aesar), 4.777 g of cerium acetylacetonate (manufactured by Sigma-Aldrich Co., LLC), and 2.048 g of zirconium acetylacetonate (manufactured by Sigma-Aldrich Co., LLC) were charged into a flask, and the mixture was heated at 160° C. for 2 hours in an environment of nitrogen flow to obtain a yellow transparent precursor solution F having a cerium concentration of 5.2 at % and a zirconium concentration of 2 at %. Approximately 100 ml of the prepared precursor solution F was filled in a gas tight syringe.

68 ml of a toluene dispersion liquid of oleic acid-coordinated In—Ce—Zr—O nanoparticles (IZCO-01) was obtained in the same manner as in the above-described synthesis of (ITCO-01), except that the precursor solution F was used instead of the precursor solution A.

The average particle diameter of the above-described IZCO particles by TEM analysis was 21 nm. In addition, in a case where a molar ratio of the constituent elements (metal elements) was measured by ICP-MS analysis, In:Ce:Zr=98.6:1.1:0.3.

### (7) Synthesis of In—Ce—Hf—O Nanoparticles (IHCO-01)

First, 420 ml of oleic acid (manufactured by FUJIFILM Wako Pure Chemical Corporation), 55.669 g of indium acetate (manufactured by Alfa Aesar), 4.777 g of cerium acetylacetonate (manufactured by Sigma-Aldrich Co., LLC), and 4.829 g of hafnium acetylacetonate (manufactured by Alfa Aesar) were charged into a flask, and the mixture was heated at 160° C. for 2 hours in an environment of nitrogen flow to obtain a yellow transparent precursor solution G having a cerium concentration of 5.2 at % and a hafnium concentration of 4 at %. Approximately 100 ml of the prepared precursor solution G was filled in a gas tight syringe.

68 ml of a toluene dispersion liquid of oleic acid-coordinated In—Ce—Hf—O nanoparticles (IHCO-01) was obtained in the same manner as in the above-described synthesis of (ITCO-01), except that the precursor solution G was used instead of the precursor solution A.

The average particle diameter of the above-described IHCO particles by TEM analysis was 21 nm. In addition, in a case where a molar ratio of the constituent elements (metal elements) was measured by ICP-MS analysis, In:Ce:Hf=98.3:1.2:0.5.

### (8) Synthesis of In—Ce—Sn—O Nanoparticles (ITCO-04) 20 ml of a toluene dispersion liquid of oleic acid-coordinated In—Ce—Sn—O nanoparticles (ITCO-04) was obtained in the same manner as in the above-described synthesis of (ITCO-01), except that the dropwise addition amount of the precursor solution A was changed from 88 ml to 9.5 ml.

The average particle diameter of the above-described ITCO particles by TEM analysis was 14 nm. In addition, in a case where a molar ratio of the constituent elements (metal elements) was measured by ICP-MS analysis, In:Ce:Sn=97.6:1.0:1.4.

### (9) Synthesis of In—Ce—Sn—O Nanoparticles (ITCO-05) 100 ml of a toluene dispersion liquid of oleic acid-coordinated In—Ce—Sn—O nanoparticles (ITCO-05) was obtained in the same manner as in the above-described synthesis of (ITCO-01), except that the dropwise addition amount of the precursor solution A was changed from 88 ml to 134 ml, the amount of oleyl alcohol was changed from 52 ml to 79 ml, and a step of holding at 290° C. for 30 minutes after adding dropwise the precursor solution A was provided.

The average particle diameter of the above-described ITCO particles by TEM analysis was 31 nm. In addition, in a case where a molar ratio of the constituent elements (metal elements) was measured by ICP-MS analysis, In:Ce:Sn=97.6:1.0:1.4.

The concentration of solid contents of the dispersion liquid of each of the oxide nanoparticles prepared above was 6% by mass, and the proportion of the surface modification component (oleic acid) to the solid content was 6% by mass.

### Method for Evaluating Concentration of Solid Contents

10 ml of the obtained dispersion liquid of each of the oxide nanoparticles was collected and heated at 200° C. for 30 minutes in a glass petri dish on a hot plate, and the concentration of solid contents was calculated from the mass of the residue after heating and the mass of the dispersion liquid before heating.

Details of the TEM analysis and the ICP-MS analysis of each of the oxide nanoparticles produced above are as follows.

### Measurement A: TEM Analysis

The average particle diameter of each of the oxide nanoparticles was calculated based on the above-mentioned method for measuring the average particle diameter of the ICO particles (A) using JFM-ARM300F2 GRAND (product name, manufactured by JEOL Ltd.) as a TEM.

### Measurement B: ICP-MS Analysis

Using an Agilent 8900 triple quadrupole (product name, manufactured by Agilent Technologies, Inc.) as ICP-MS, concentrations of indium, cerium, tin, zirconium, and hafnium in the particles were measured.

### 2. Synthesis of Dispersant

### Synthesis of Dispersant (A-1)

24.0 g of methyl methacrylate (manufactured by FUJIFILM Wako Pure Chemical Corporation) and 1.80 g of mercaptosuccinic acid (manufactured by FUJIFILM Wako Pure Chemical Corporation) were dissolved in 28 mL of methyl ethyl ketone and heated to 70° C. under a nitrogen stream. A solution in which 0.24 g of a polymerization initiator (manufactured by FUJIFILM Wako Pure Chemical Corporation, V-65) was dissolved in 12 mL of methyl ethyl ketone was added dropwise to this solution over 30 minutes. After the completion of the dropwise addition, the reaction was further performed at 70° C. for 4.5 hours. After allowing to cool, the reaction solution was added dropwise to a cooled mixed solution of 200 mL of water and 600 mL of methanol, and the precipitated powdery substance was collected by filtration and dried to obtain 15 g of the following dispersant (A-1). The polymer dispersant (A-1) was substantially composed of a polymer having a carboxy group at one terminal.

The weight-average molecular weight of the obtained polymer was 5900 in terms of standard polystyrene according to a gel permeation chromatography (GPC) method, and the dispersity (Mw/Mn) was 1.70. In addition, in a case where the number in mg of potassium hydroxide required to neutralize free fatty acid present in 1 g of the obtained polymer was measured to obtain an acid value, the acid value was 24 mgKOH/g.

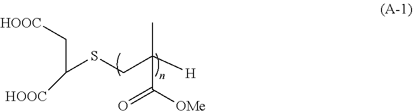

### Example

The toluene dispersion liquids of the oxide nanoparticles prepared above were diluted with toluene in advance so that the concentration of solid contents was 5% by mass, and each curable resin composition was prepared as follows.

### 1. Preparation of Curable Resin Compositions 1-1 to 1-9

0.535 g of the dispersant (A-1) and 2.02 g of 1,6-hexanediol dimethacrylate (HDDMA, manufactured by TOKYO CHEMICAL INDUSTRY CO., LTD.) were added to 48.8 g (solid content: 5%, 2.44 gas the ITCO particles) of the toluene dispersion liquid of (ITCO-01) to be dissolved. Toluene was distilled off by suction under reduced pressure while heating in a water bath at approximately 70° C. After the distillation, 0.01 g of IRGACURE 819 (product name, manufactured by BASF, photoradical polymerization initiator) was added to the obtained mixture and dissolved, thereby preparing a curable resin composition 1-1.

Curable resin compositions 1-2 to 1-9 were prepared in the same manner as in the above-described preparation of the curable resin composition 1-1, except that the type of the oxide nanoparticles was changed to have the configuration shown in the table below.

### 2. Preparation of Curable Resin Composition 2

22.3 g of FA-512AS (product name, dicyclopentenyloxyethyl acrylate, manufactured by Hitachi Chemical Co., Ltd.) was added to 82.1 g of a zirconium oxide dispersion liquid (product name: SZR-K, manufactured by SAKAI CHEMICAL INDUSTRY CO., LTD.) and stirred until uniform. Methanol and methyl ethyl ketone (MEK) were distilled off by suction under reduced pressure while heating in a water bath at approximately 70° C. After the distillation, 0.20 g of IRGACURE 651 (product name, photoradical polymerization initiator, manufactured by BASF) was added to the obtained mixture and dissolved, thereby preparing a curable resin composition 2.

### 3. Production of Cured Products of Curable Resin Compositions 1-1 to 1-9

The curable resin composition 1-1 was sandwiched between hydrophobically treated glass plates, irradiated with ultraviolet light (UV) under the conditions of integrated light intensity of 1.0 J/cm² and illuminance of 30 mW/cm² using a UV irradiation device (product name: EXECURE 3000, manufactured by HOYA CANDEO OPTRONICS CORPORATION), and irradiated again with UV under the conditions of integrated light intensity of 1.0 J/cm² and illuminance of 5 mW/cm² to produce a cured product. The film thickness of the cured product obtained as described above was 6 μm.

Cured products of the curable resin compositions 1-2 to 1-9 were produced in the same manner as in the production of the cured product of the curable resin composition 1-1, except that the curable resin compositions 1-2 to 1-9 were used instead of the curable resin composition 1-1.

### 4. Production of Cured Product of Curable Resin Composition 2

The curable resin composition 2 was sandwiched between hydrophobically treated glass plates, irradiated with UV under the conditions of integrated light intensity of 2.0 J/cm² and illuminance of 5 mW/cm² using a UV irradiation device (product name: EXECURE 3000, manufactured by HOYA CANDEO OPTRONICS CORPORATION) to produce a cured product. The film thickness of the cured product obtained as described above was 6 μm.

### Evaluation 1: Transmittance Measurement

With regard to the cured product of each curable resin composition produced under the above-described conditions, using a spectrophotometer (product name: V-670, manufactured by JASCO Corporation), transmittance in a wavelength of 400 to 1800 nm was measured, and a transmittance of the cured product was evaluated according to the following evaluation standard based on a transmittance %T₈₅₂ at 852 nm and a transmittance %T₁₆₅₀ at 1650 nm. In the following evaluation standard, an evaluation A is the best, followed by B, C, D, and E in this order, and F is the worst. The results are shown in Table 1.

### Evaluation Standard

A: %T₈₅₂ was 90% or more and %T₁₆₅₀ was 60% or more

B: %T₈₅₂ was 90% or more, and %T₁₆₅₀ was 50% or more and less than 60%

C: %T₈₅₂ was 90% or more, and %T₁₆₅₀ was 40% or more and less than 50%

D: %T₈₅₂ was 90% or more, and %T₁₆₅₀ was 30% or more and less than 40%

E: %T₈₅₂ was 90% or more and %T₁₆₅₀ was less than 30%

F: %T₈₅₂ was less than 90% (the value of %T₁₆₅₀ did not matter)

### Evaluation 2: Evaluation of Refractive Index

With regard to each cured product of the above-described curable resin compositions 1-1 to 1-9 and the above-described curable resin composition 2, a refractive index n852 at a wavelength of 852 nm and a refractive index n1530 at 1530 nm were measured using spectral ellipsometry. The evaluation was performed by measuring ellipsometry data and transmittance data of the cured products and performing simultaneous fitting. Detailed conditions of the ellipsometry are as follows.

Incidence angle: 50°, 60°, 70°

Measurement wavelength: 210 to 1690 nm

Optical model: harmonized oscillator model considering the relationship between absorption and Kramers-Kronig

In the cured product of the curable resin composition 2, n852=1.608 and n1530=1.605. In the cured products of the curable resin compositions 1-1 to 1-9, n852 and n1530 are collectively shown in Table 1.

All of the n852 values of the cured products of the curable resin compositions 1-1 to 1-9 were smaller than the n852 value of the cured product of the curable resin composition 2, and all of the n1530 values of the cured products of the curable resin compositions 1-1 to 1-9 were smaller than the n1530 value of the cured product of the curable resin composition 2. In addition, all of n852−n1530 values of the cured products of the curable resin compositions 1-1 to 1-9 were larger than n852−n1530=0.003 of the cured product of the curable resin composition 2.

### Evaluation 3: Evaluation of Chromatic Aberration Reducing Effect of Multilayer Diffractive Optical Element

In a diffractive optical element shown in FIG. 2 of JP2008-241734A, using a cured product of a resin composition of the combination described in Table 2, any one of the above-described cured products of the curable resin compositions 1-1 to 1-11 was used as a first diffraction grating and the above-described cured product of the curable resin composition 2 was used as a second diffraction grating, and a chromatic aberration reducing effect of the multilayer diffractive optical element was evaluated in a case where a common lattice thickness of the first and second diffraction gratings was 12 μm.

For the chromatic aberration reducing effect of the multilayer diffractive optical element, using expressions 23 and 24 of JP2008-241734 and values of the refractive index and lattice thickness measured in the above-described evaluation 2, the diffraction efficiencies with primary light at the wavelength of 852 nm and the wavelength of 1530 nm were calculated, respectively, and the evaluation was performed according to the following evaluation standard. As the diffraction efficiency is larger, occurrence of flare in the lens can be more suppressed and the chromatic aberration can be further reduced. In the following evaluation standard, an evaluation A is the best, followed by B⁺, B⁻, C⁺, and C⁻ in this order, and D is the worst. The results are shown in Table 1.

### Evaluation Standard

A: diffraction efficiency at the wavelength of 852 nm was 95% or more, and the diffraction efficiency at the wavelength of 1530 nm was 95% or more.

B⁺: diffraction efficiency at the wavelength of 852 nm was 95% or more, and the diffraction efficiency at the wavelength of 1530 nm was 90% or more and less than 95%.

B⁻: diffraction efficiency at the wavelength of 852 nm was 95% or more, and the diffraction efficiency at the wavelength of 1530 nm was 85% or more and less than 90%.

C⁺: diffraction efficiency at the wavelength of 852 nm was 85% or more and less than 95%, and the diffraction efficiency at the wavelength of 1530 nm was 95% or more.

C⁻: diffraction efficiency at the wavelength of 852 nm was 85% or more and less than 95%, and the diffraction efficiency at the wavelength of 1530 nm was 85% or more and less than 95%.

D: at least one of the diffraction efficiency at the wavelength of 852 nm or the diffraction efficiency at the wavelength of 1530 nm was less than 85%.

TABLE 1

| | | | Com- | | | | | | | |
|---|---|---|---|---|---|---|---|---|---|---|
| | | Example | parative | Example | Example | Example | Example | Example | Example | Example |
| | | 1 | Example 1 | 2 | 3 | 4 | 5 | 6 | 7 | 8 |
| Curable resin composition | | 1-1 | 1-2 | 1-3 | 1-4 | 1-5 | 1-6 | 1-7 | 1-8 | 1-9 |
| Oxide nanoparticles | Type | ITCO- | ITO- | ICO- | ITCO- | ITCO- | IZCO-01 | IHCO-01 | ITCO-04 | ITCO-05 |
| | | 01 | 01 | 01 | 02 | 03 | | | | |
| | Constituent | In. Ce, | In. Sn | In, Ce | In, Ce, | In, Ce. | In. Ce, Zr | In. Ce, Hf | In. Ce, Sa | In, Ce. Sa |
| | element | Sn | | | Sn | Sn | | | | |
| | Ce concentration | 1.0 | 0.0 | 1.2 | 3.4 | 0.7 | 1.1 | 1.2 | 1.0 | 1.0 |
| | [at %] | | | | | | | | | |
| | Zr + Sn + Hf | 1.4 | 1.4 | 0.0 | 1.3 | 2.4 | 0.3 | 0.5 | 1.4 | 1.4 |
| | concentration | | | | | | | | | |
| | [at %] | | | | | | | | | |
| | Average particle | 21 | 21 | 21 | 21 | 21 | 21 | 21 | 14 | 31 |
| | diameter [nm] | | | | | | | | | |
| | Blending amount | 48.8 | 48.8 | 48.8 | 48.8 | 48.8 | 48.8 | 48.8 | 48.8 | 48.8 |
| | [wt %] | | | | | | | | | |
| Dispersant: A-1 | Blending amount | 10.7 | 10.7 | 10.7 | 10.7 | 10.7 | 10.7 | 10.7 | 10.7 | 10.7 |
| | [wt %] | | | | | | | | | |
| (Meth)acrylate | Blending amount | 40.4 | 40.4 | 40.4 | 40.4 | 40.4 | 40.4 | 40.4 | 40.4 | 40.4 |
| compound: | [wt %] | | | | | | | | | |
| HDDMA | | | | | | | | | | |
| Photoradical | Blending amount | 0.2 | 0.2 | 0.2 | 0.2 | 0.2 | 0.2 | 0.2 | 0.2 | 0.2 |
| polymerization | [wt %] | | | | | | | | | |
| initiator: | | | | | | | | | | |
| IRGACURE 819 | | | | | | | | | | |

| | | | | | | | | | |
|---|---|---|---|---|---|---|---|---|---|
| n852 | 1.534 | 1.533 | 1.539 | 1.534 | 1.532 | 1.539 | 1.539 | 1.535 | 1.536 |
| a1530 | 1.474 | 1.474 | 1.502 | 1.493 | 1.466 | 1.486 | 1.488 | 1.479 | 1.490 |
| Transmittance of cured product | A | D | A | A | B | A | A | B | B |
| Chromatic aberration reducing effect of | A | A | B- | B+ | A | B+ | B+ | A | A |
| multilayer diffractive optical element | | | | | | | | | |

Note to table
Each component in the tables is as follows.
Oxide nanoparticles
Each of oxide nanoparticles prepared above
Dispersants
A-1: dispersant (A-1) produced above
(Meth)acrylate compound
HDDMA: 1,6-hexanediol dimethacrylate
Photoradical polymerization initiator
IRGACURE 819 (also referred to as Irgacure 819): product name, manufactured by BASF

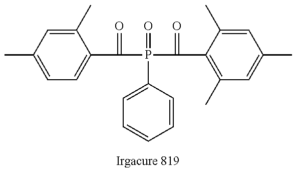

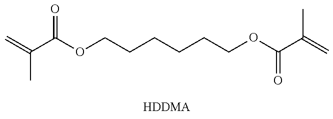 [SMILES: C=C(C)C(=O)OCCCCCCOC(=O)C(=C)C]

The unit of the blending amount is % by mass (also referred to as wt %), and the blending amount of the oxide nanoparticles is described by the solid content amount.

The units of the cerium concentration (Ce concentration) and the total concentration of zirconium, tin, and hafnium (Zr+Sn+Hf concentration) are all at %.

The unit of the average particle diameter of the oxide nanoparticles is nm.

In the column of constituent element, a metal element qualitatively determined by the ICP-MS analysis is described.

From the results shown in Table 1, the following is found.

With the cured product obtained from the comparative curable resin composition 1-2 containing the indium tin oxide (ITO) nanoparticles, which has a low transmittance of less than 40% at 1650 nm, a cured product which exhibits high transmittance over the near-infrared wavelength region to the shortwave infrared wavelength region while maintaining a wavelength dependence of a desired refractive index cannot be realized.

On the other hand, with the cured product obtained from any one of the curable resin compositions 1-1 and 1-3 to 1-9 according to the embodiment of the present invention, which contain the oxide nanoparticles including indium and cerium, the monofunctional or higher functional (meth)acrylate compound, and the dispersant, a cured product, which exhibits a desired wavelength dependence of the refractive index over the near-infrared region to the shortwave infrared region, and in a case of being used in a multilayer diffractive optical element, has a desired chromatic aberration reducing effect over the near-infrared wavelength region to the shortwave infrared wavelength region, can be obtained. Moreover, a high transmittance can be achieved while maintaining the desired wavelength dependence of the refractive index over the near-infrared region to the shortwave infrared region, and compared to the case of using ITO nanoparticles, the transmittance in the shortwave infrared wavelength region was excellent.

What is claimed is:

1. A curable resin composition comprising:
oxide nanoparticles including indium and cerium;
a monofunctional or higher functional (meth)acrylate compound; and
a dispersant.

2. The curable resin composition according to claim 1,
wherein the oxide nanoparticles include at least one element of zirconium, hafnium, or tin.

3. The curable resin composition according to claim 2,
wherein the oxide nanoparticles include tin.

4. The curable resin composition according to claim 1,
wherein a cerium concentration of the oxide nanoparticles is 0.5 to 3.0 at %.

5. The curable resin composition according to claim 2,
wherein a total concentration of zirconium, hafnium, and tin in the oxide nanoparticles is 0.1 to 2.0 at %.

6. The curable resin composition according to claim 1,
wherein a content of the oxide nanoparticles in the curable resin composition is 10% to 60% by mass.

7. The curable resin composition according to claim 1,
wherein an average particle diameter of the oxide nanoparticles is 16 to 30 nm.

8. The curable resin composition according to claim 7,
wherein the average particle diameter of the oxide nanoparticles is 20 to 30 nm.

9. The curable resin composition according to claim 1, further comprising:
a photoradical polymerization initiator.

10. A cured product obtained by curing the curable resin composition according to claim 1.

11. The cured product according to claim 10,
wherein a refractive index at a wavelength of 852 nm is 1.500 to 1.650.

12. The cured product according to claim 10,
wherein a refractive index at a wavelength of 1530 nm is 1.300 to 1.550.

13. A diffractive optical element including a surface which is formed of the cured product according to claim 10 and has a diffraction grating shape.

14. A multilayer diffractive optical element comprising:
a first diffractive optical element; and
a second diffractive optical element,
wherein the first diffractive optical element is the diffractive optical element according to claim 13, and
a surface of the first diffractive optical element, which has a diffraction grating shape, and a surface of the second diffractive optical element, which has a diffraction grating shape, face each other.

15. The multilayer diffractive optical element according to claim 14,
wherein a refractive index of the second diffractive optical element at a wavelength of 852 nm is 1.550 to 1.700, and the refractive index is larger than a refractive index of the first diffractive optical element at the wavelength of 852 nm.

16. The multilayer diffractive optical element according to claim 14,
wherein the surface of the first diffractive optical element, which has a diffraction grating shape, and the surface of the second diffractive optical element, which has a diffraction grating shape, are in contact with each other.

17. The multilayer diffractive optical element according to claim 14, further comprising:
a transparent substrate,
wherein the first diffractive optical element, the second diffractive optical element, and the transparent substrate are arranged in this order.

18. Oxide nanoparticles comprising:
indium;
cerium; and
at least one element of tin, zirconium, or hafnium,
wherein an average particle diameter is 16 to 30 nm.

19. An additive for a lens which is used for adjusting a wavelength dependence of a refractive index, the additive comprising:
the oxide nanoparticles according to claim 18.
